(19) United States
(12) Patent Application Publication
(10) Pub. No.: US 2008/0076030 A1
(43) Pub. Date: Mar. 27, 2008

(54) NONAQUEOUS ELECTROLYTE BATTERY, BATTERY PACK AND VEHICLE

(76) Inventors: Hiroki Inagaki, Kawasaki-shi (JP); Hidesato Saruwatari, Saku-shi (JP); Norio Takami, Yakohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/855,587

(22) Filed: Sep. 14, 2007

(30) Foreign Application Priority Data
Sep. 27, 2006 (JP) 2006-263040

(51) Int. Cl. H01M 10/40

(52) U.S. Cl. 429/330; 429/337

(57) ABSTRACT

A nonaqueous electrolyte battery includes a positive electrode, a negative electrode and a nonaqueous electrolyte. The positive electrode contains a positive electrode active material represented by the formula LiₓCo_{1-y}M_{y}O₂. The negative electrode contains a lithium-titanium composite oxide having a spinel structure. The nonaqueous electrolyte contains a γ-butyrolactone-containing nonaqueous solvent, 0.01 to 0.5% by weight of a first lithium salt being at least one of lithium salts represented by the following chemical formula (1) or (2), and 1 to 2.5 M/L of a second lithium salt being at least one selected from the group consisting of LiBF₄ and LiPF₆.

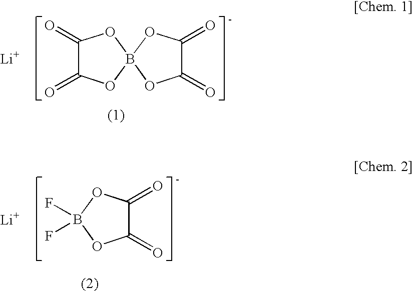

### CROSS-REFERENCE TO RELATED APPLICATIONS

This application is based upon and claims the benefit of priority from prior Japanese Patent Application No. 2006-263040, filed Sep. 27, 2006, the entire contents of which are incorporated herein by reference.

### BACKGROUND OF THE INVENTION

1. Field of the Invention

The present invention relates to a nonaqueous electrolyte battery, and a battery pack and a vehicle provided with this nonaqueous electrolyte battery.

2. Description of the Related Art

In nonaqueous electrolyte batteries, lithium ions are transferred between a negative electrode and a positive electrode to charge and discharge. These nonaqueous electrolyte batteries have been researched and developed as high-energy density batteries.

These nonaqueous electrolyte batteries are desired to have various abilities depending on the purpose. For example, it is desirable for the nonaqueous electrolyte battery used as a power source of a digital camera to achieve the discharge not lower than about 3 C, and for the nonaqueous electrolyte battery mounted to a vehicle such as a hybrid automobile to achieve the discharge not lower than about 10 C. For this reason, it is particularly desired for nonaqueous electrolyte batteries to have a large-current performance and long charge-discharge cycle life when charge-discharge is repeated under a large current.

Nonaqueous electrolyte batteries using a lithium-transition metal composite oxide as a positive electrode active material and a carbonaceous material as a negative electrode active material have already been commercialized. Generally, Co, Mn, Ni or the like is used as the transition metal component of the lithium-transition metal composite oxide.

A nonaqueous electrolyte battery using a lithium titanium composite oxide having a higher lithium ion absorption potential than a carbonaceous material as the negative electrode active material has been recently proposed. A lithium-titanium composite oxide is reduced in the variation of volume associated with charge and discharge and is therefore superior in cycle performance. Among these lithium-titanium composite oxides, lithium titanate having a spinel structure is especially promising.

For example, JP-A 2006-40896 (KOKAI) discloses a lithium ion battery using lithium titanate as the negative electrode active material and lithium-nickel oxide as the positive electrode active material, and further using at least one of LiPF₆, LiBF₄, LiBOB and LiBETI as a lithium salt. As the lithium-nickel oxide, a compound represented by the formula LiNi_{1-x-y}CoₓAl/Mn_{y}O₂ (Al/Mn is at least one of Al and Mn, 0≦x≦0.5, 0≦y≦0.5, x+y=less than 0.66) is used. Also, in JP-A 2006-40896 (KOKAI), there is a description that the cycle life in a heat cycle test is reduced when LiCoO₂ is used as the positive electrode active material of the above lithium ion battery.

### BRIEF SUMMARY OF THE INVENTION

According to a first aspect of the present invention, there is provided a nonaqueous electrolyte battery, comprising:

a positive electrode containing a positive electrode active material represented by the formula LiₓCo_{1-y}M_{y}O₂ (M is at least one selected from the II group to XIV group metals except for Co, 0≦x≦1.1, 0≦y<0.5);

a negative electrode containing a negative electrode active material which is a lithium-titanium composite oxide having a spinel structure; and

a nonaqueous electrolyte containing a nonaqueous solvent containing γ-butyrolactone, 0.01 to 0.5% by weight of a first lithium salt which is dissolved in the nonaqueous solvent and is at least one of lithium salts represented by the following chemical formula (1) or (2), and 1 to 2.5 M/L of a second lithium salt which is dissolved in the nonaqueous solvent and is at least one selected from the group consisting of LiBF₄ and LiPF₆.

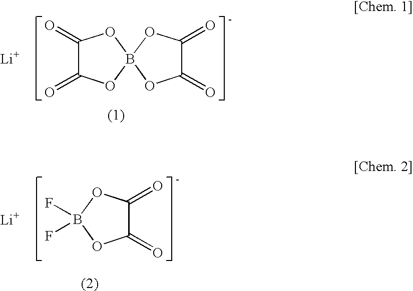

According to a second aspect of the present invention, there is provided a battery pack comprising a nonaqueous electrolyte battery,

wherein the nonaqueous electrolyte battery comprises:

a positive electrode containing a positive electrode active material represented by the formula LiₓCo_{1-y}M_{y}O₂ (M is at least one selected from the II group to XIV group metals except for Co, 0≦x≦1.1, 0≦y<0.5);

a negative electrode containing a negative electrode active material which is a lithium-titanium composite oxide having a spinel structure; and

a nonaqueous electrolyte containing a nonaqueous solvent containing γ-butyrolactone, 0.01 to 0.5% by weight of a first lithium salt which is dissolved in the nonaqueous solvent and is at least one of lithium salts represented by the following chemical formula (1) or (2), and 1 to 2.5 M/L of a second lithium salt which is dissolved in the nonaqueous solvent and is at least one selected from the group consisting of LiBF₄ and LiPF₆.

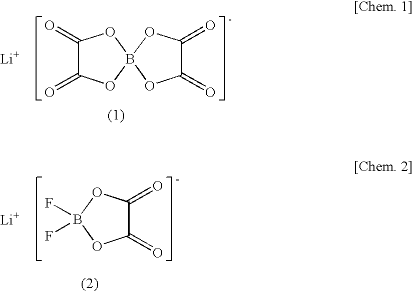

### BRIEF DESCRIPTION OF THE SEVERAL VIEWS OF THE DRAWING

FIG. 1 is a sectional typical view of a flat type nonaqueous secondary battery according to a first embodiment;

FIG. 2 is a sectional typical view showing the details of a part enclosed by a circle shown by A in FIG. 1;

FIG. 3 is a partially broken view showing an another nonaqueous electrolyte battery according to the first embodiment;

FIG. 4 is a partially sectional typical view showing the details of a part enclosed by a circle shown by B in FIG. 3;

FIG. 5 is a perspective view typically showing an electrode group having a laminate structure used in a nonaqueous electrolyte battery according to the first embodiment;

FIG. 6 is an exploded perspective view of a battery pack according to a second embodiment;

FIG. 7 is a block diagram showing an electric circuit of the battery pack of FIG. 6;

FIG. 8 is a typical view showing a series hybrid car according to a third embodiment;

FIG. 9 is a typical view showing a parallel hybrid car according to the third embodiment;

FIG. 10 is a typical view showing a series-parallel hybrid car according to the third embodiment;

FIG. 11 is a typical view showing a sedan type automobile according to the third embodiment;

FIG. 12 is a typical view showing a hybrid motorcycle according to the third embodiment;

FIG. 13 is a typical view showing an electric motorcycle according to the third embodiment;

FIG. 14 is a typical view showing a rechargeable vacuum cleaner according to a fourth embodiment;

FIG. 15 is a structural view of the rechargeable vacuum cleaner of FIG. 14;

FIG. 16 is a diagram showing a charge-discharge curve of a battery of Comparative Example 1; and

FIG. 17 is a partially broken perspective view showing a rectrectangular type nonaqueous electrolyte battery according to the first embodiment.

### DETAILED DESCRIPTION OF THE INVENTION

The inventors of the present invention have made earnest studies and as a result, found that a nonaqueous electrolyte battery using a lithium-titanium composite oxide having a spinel structure as the negative electrode active material gives rise to the problems such as those mentioned below.

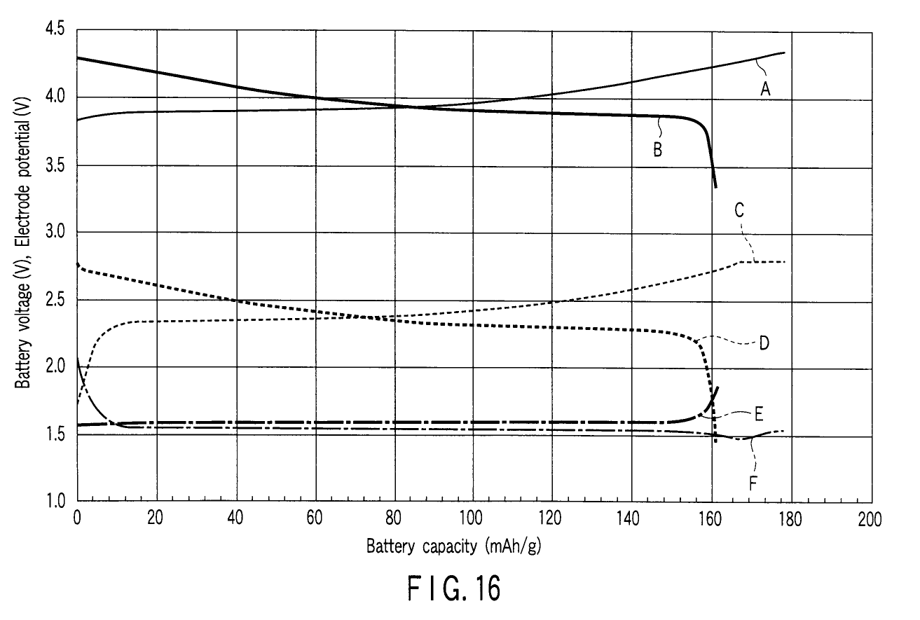

Lithium-titanium composite oxide having a spinel structure is reduced in volume variation along with charge and discharge, that is, the absorption or desorption of lithium ions and is therefore superior in charge and discharge cycle characteristics. Also, lithium-titanium composite oxide having a spinel structure has a high charge-discharge efficiency of the first charge-discharge cycle. In the case of combining a negative electrode using this lithium-titanium composite oxide with a positive electrode using, as the positive electrode active material, a 4 V type transition metal oxide having a low first charge-discharge efficiency and typified by lithium-cobalt oxide, the discharge cutoff voltage of the positive electrode drops. A drop in the discharge cutoff voltage is significantly promoted when the 4 V type transition metal oxide has a layered crystal structure. In the condition that the discharge cutoff voltage of the positive electrode drops, the change in the battery voltage is greatly dependent on the change of the positive electrode potential. This condition is shown in FIG. 16. In FIG. 16, the abscissa is the capacity (mAh/g) of a battery and the ordinate is the voltage (V) of a battery or the potential of an electrode (V vs. Li/Li⁺). Curve A shows the charge potential of the positive electrode, curve B shows the discharge potential of the positive electrode, curve C shows the charge voltage of the battery, curve D shows the discharge voltage of the battery, curve E shows the discharge potential of the negative electrode and curve F shows the charge potential of the negative electrode.

First, this battery is so designed that a cutoff mechanism works when the discharge voltage (curve D) is below a predetermined value (here, 1.5 V). Because as shown in FIG. 16, the potential of the positive electrode (curve B) largely drops close to 3 V before the potential of the negative electrode (curve E) is raised in the last stage of the discharge, the voltage (curve D) of the battery drops due to the drop in the discharge potential of the positive electrode and the cutoff works. Specifically, the change of the battery voltage is dependent on the change of the positive electrode potential.

Lithium titanate that is one example of spinel type lithium-titanium composite oxides exhibits a good cycle performance at 1 to 3 V (vs. Li/Li⁺). In the case of a positive electrode containing a 4 V type transition metal oxide represented by the formula LiₓCo_{1-y}M_{y}O₂ (M is at least one selected from the II group to XIV group metals except for Co, 0≦x≦1.1, 0≦y<0.5), a reduction in capacity caused by collapse of a crystal structure is significant if charge-discharge cycle is repeated at a potential close to and below 3 V (vs. Li/Li⁺). This is the reason why excellent charge-discharge performance is not obtained. Such deterioration arises significantly when the discharge final voltage of a battery is made lower. It has been found that especially, in the case where the over-discharge deterioration of the positive electrode is large and particularly in the case of combining an electrolytic solution containing γ-butyrolactone, elution of cobalt from the positive electrode is so significant that over-discharge deterioration is further promoted.

In order to improve the cycle performance of a nonaqueous electrolyte battery using lithium-titanium composite oxide having a spinel structure as the negative electrode active material and a positive electrode active material represented by the formula LiₓCo_{1-y}M_{y}O₂ (M is at least one selected from the II group to XIV group metals except for Co, 0≦x≦1.1, 0≦y<0.5) as the positive electrode active material, a nonaqueous electrolyte provided with the following (a) to (e) is used in the embodiment of the present invention.

(a) A nonaqueous solvent containing γ-butyrolactone.

(b) A first lithium salt which is dissolved in the above nonaqueous solvent and is at least one of lithium salts represented by the following chemical formula (1) or (2).

(c) The first lithium salt is 0.01% by weight or more and 0.5% by weight or less when the nonaqueous electrolyte is 100% by weight.

(d) A second lithium salt which is dissolved in the above nonaqueous solvent and is at least one selected from LiBF₄ and LiPF₆.

(e) The concentration of the second lithium salt in the nonaqueous solvent is 1 M/L or more and 2.5 M/L or less.

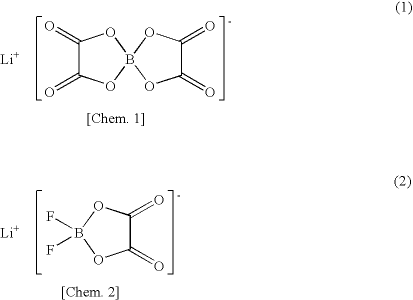

The first lithium salt is reduced at a potential higher than the lithium ion absorption potential of a lithium-titanium composite oxide having a spinel structure. In the first charging stage, the first lithium salt reacts with the negative electrode active material or negative electrode conductive agent contained in the negative electrode, and then lithium ions supplied from the positive electrode are absorbed in the negative electrode active material. In the first discharging stage, the lithium ions absorbed in the negative electrode active material are desorbed and absorbed in the positive electrode active material. Because the quantity of electricity of the negative electrode in the first charging stage is increased by the reaction between the first lithium salt and the negative electrode, the first charge-discharge efficiency of the negative electrode can be more dropped than that of the positive electrode, successfully resulting in that the change of the battery discharge voltage is dependent on the change of the negative electrode discharge potential. As a result, the discharge cutoff potential of the positive electrode can be raised, so that the collapse of the crystal structure of the positive electrode can be limited, whereby the cycle performance of the battery can be improved.

The first lithium salt to be contained in the nonaqueous electrolyte is caused to react on the surface of the negative electrode, thereby making it possible to drop (control) the first charge-discharge efficiency of the negative electrode. When the content of the first lithium salt in the nonaqueous electrolyte is made to be less than 0.01% by weight, the over-discharge of the positive electrode is not limited. When the content of the first lithium salt in the nonaqueous electrolyte exceeds 0.5% by weight, gas is significantly generated, increasing the resistance of the battery. This results in reduced capacity and output. The content of the first lithium salt is preferably 0.2% by weight or more and 0.5% by weight or less (when the nonaqueous electrolyte is set to 100% by weight).

As mentioned above, excess addition of the first lithium salt decreases the conductivity of the electrolyte, inducing significant generation of gas. It is therefore desirable to combine a second lithium salt which has high solubility and is resistant to side reactions. When the second lithium salt is contained in an amount of 1 M/L or more and 2.5 M/L or less in the nonaqueous electrolyte, the cycle performance can be improved by reducing the first charge-discharge efficiency of the negative electrode. The first lithium salt is scarcely dissolved in a nonaqueous solvent and is dissolved in an amount of only about 0.7 M/L in the case of, for example, LiBOB, though depending on the composition of the solvent. The first charge-discharge efficiency of the negative electrode can be decreased even if the content of the second lithium salt in the nonaqueous electrolyte is designed to be less than 1 M/L. However, it is difficult to increase the ion conductivity of the nonaqueous electrolyte and therefore, the cycle performance is not improved and input/output performances of the negative electrode, load discharge characteristics and low-temperature performance deteriorate. Also, even if the content of the second lithium salt exceeds 2.5 M/L, it is possible to decrease the first charge-discharge efficiency of the negative electrode when the content of the first lithium salt in the nonaqueous electrolyte is 0.01% by weight or more and 0.5% by weight or less. However, the viscosity of the nonaqueous electrolyte is increased and ionic conductivity is decreased, with the result that the cycle performance cannot be improved. The content of the second lithium salt is preferably 1.2 M/L or more and 2 M/L or less.

In order to suppress over-discharge of the positive electrode, it is effective to decrease the first charge-discharge efficiency of the negative electrode by 2% or more than the first charge-discharge efficiency of the positive electrode. Specifically, it is necessary that the amount of the first lithium salt to be caused to react on the surface of the negative electrode be 2% or more of the amount of electricity of the negative electrode. The inventors of the present invention have made earnest studies and as a result, found that the amount of the first lithium salt to be caused to react on the surface of the negative electrode is strongly correlated to the surface area of the negative electrode. Moreover, it has been also found that on the surface of the negative electrode, the reaction occurs more extensively on the surface of a carbonaceous material than on the surface of an oxide such as lithium-titanium composite oxide. When comparing the amounts of the first lithium salt to be caused to react in the same area, it has been found that the amount of reaction on the carbonaceous material is about 10 times that on the lithium-titanium composite oxide.

Based on the above results, the specific surface area of the negative electrode excluding a current collector is preferably 4 m²/g or more and more preferably 7 m²/g or more. At this time, the value of the equation (3) is preferably made to be 4 or more when the specific surface area of the negative electrode active material is A (m²/g) and the specific surface area of the carbonaceous material which is to be the negative electrode conductive agent is B (m²/g). Here, a and b are the amounts of the negative electrode active material and negative electrode conductive agent, respectively. The value of the equation (3) is preferably 10 or more.

A×a/(a+b)+10B×b/(a+b) (3)

Embodiments of the present invention will be explained below with reference to the drawings. Structures common to these embodiments are represented by the same symbols and duplicated explanations thereof are omitted. Also, each drawing is a typical view for explaining the embodiments and for promoting the understanding of the embodiments. Although in these drawings, there are parts differing from those of an actual device in shape, dimension and ratio, the designs of them may be changed appropriately in consideration of the following explanations and known technologies.

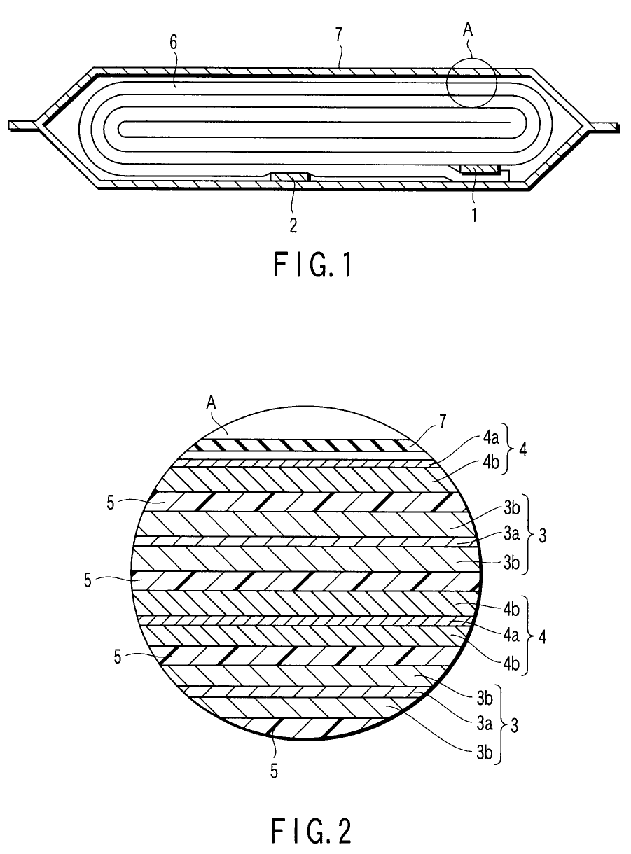

Explanations will be furnished as to the structure of one example of a nonaqueous electrolyte battery according to the present invention with reference to FIGS. 1 and 2. FIG. 1 shows a sectional typical view of a flat type nonaqueous electrolyte secondary battery according to the embodiment of the present invention. FIG. 2 shows a partially sectional typical view showing the details of a part enclosed by the circle shown by A in FIG. 1.

As shown in FIG. 1, a flat-shape coiled electrode group 6 is housed in an outer package member 7. The coiled electrode group 6 has a structure in which a positive electrode 3 and a negative electrode 4 are spirally coiled through a separator 5. A nonaqueous electrolyte is held in the coiled electrode group 6.

As shown in FIG. 2, the negative electrode 4 is positioned on the outermost periphery of the coiled electrode group 6, and the positive electrodes 3 and the negative electrodes 4 are alternately laminated through each separator 5 in such a manner that on the inside periphery of the negative electrode 4, a separator 5, positive electrode 3, separator 5, negative electrode 4, separator 5, positive electrode 3, separator 5 . . . are laminated in this order. The negative electrode 4 is provided with a negative electrode current collector 4a and a negative electrode active material-containing layer 4b supported by the negative electrode current collector 4a. The negative electrode active material-containing layer 4b is formed on only one surface of the negative electrode current collector 4a at a part positioned on the outermost periphery of the negative electrode 4. The positive electrode 3 is provided with a positive electrode current collector 3a and a positive electrode active material-containing layer 3b supported by the positive electrode current collector 3a.

As shown in FIG. 1, a band-shaped positive electrode terminal 1 is electrically connected to the positive electrode current collector 3a in the vicinity of the outer peripheral end of the coiled electrode group 6. On the other hand, a band-shaped negative electrode terminal 2 is electrically connected to the negative electrode current collector 4a in the vicinity of the outer peripheral end of the coiled electrode group 6. Each end of the positive electrode terminal 1 and the negative electrode terminal 2 is drawn externally from the same side of the outer package member 7.

The negative electrode, nonaqueous electrolyte, positive electrode, separator, outer package member, positive electrode terminal and negative electrode terminal will be explained in detail.

1) Negative Electrode

The negative electrode comprises a negative electrode current collector and a negative electrode active material-containing layer that is laminated on one or both surfaces of the negative electrode current collector and includes a negative electrode active material, a negative electrode conductive agent and a binder.

The major negative electrode active material to be contained in the negative electrode is a lithium-titanium composite oxide having a spinel structure. The formula of its composition may be expressed by, for example, Li₄₊ₓTi₅O₁₂ (x: 0≦x≦3). A part of the structural elements of this lithium-titanium oxide may be substituted with a dissimilar element.

The reason why a most preferable material is limited to lithium-titanium composite oxides having a spinel structure is because lithium-titanium composite oxides having a spinel structure is a material having a very high first charge-discharge efficiency. The embodiment of the present invention is particularly effective when a lithium-titanium composite oxide as the negative electrode active material is combined with lithium-cobalt composite oxide as the positive electrode active material.

When the first charge-discharge efficiency of the negative electrode active material is higher than that of the positive electrode active material, the battery in the discharge final stage is put into a cut-off state by the change of the positive electrode potential. In this case, the potential of the positive electrode in the stage of final discharge drops to a value close to 3 V (vs. Li/Li⁺) so that the positive electrode is put into an over-discharge state. Therefore, the deterioration of the positive electrode is accelerated, which brings about deterioration in the performance of the battery. Specifically, the positive electrode is preferably used out of a voltage range where a significant drop of potential in the final discharge stage of the positive electrode arises.

The effect of improving the cycle performance is produced by reducing the first lithium salt on the surface of the negative electrode. The reduced quantity has a strong correlation with the surface area of the negative electrode, and the present invention efficiently functions when the surface area of the negative electrode is 4 m²/g or more. The negative electrode specific surface area means the BET specific surface area measured by N₂ gas adsorption. This specific surface area may be measured by using Shimadzu Micromelitex ASAP-2010 (trade name, manufactured by Shimadzu Corporation) and N₂ as the adsorption gas.

In a more preferable condition, the value calculated by the following equation (3) given by each specific surface area and content of the negative electrode active material and negative electrode conductive agent is 4 or more and more preferably 10 or more.

A×a/(a+b)+10B×b/(a+b) (3)

Here, A is the BET specific surface area of the negative electrode active material (m²/g), B is the BET specific surface area of the negative electrode conductive agent (m²/g), a is the content of the negative electrode active material in the negative electrode active material-containing layer (parts by weight) and b is the content of the negative electrode conductive agent in the negative electrode active material-containing layer (parts by weight).

When the value given by the above equation (3) is less than 4, the quantity of reducing reaction on the surface of the negative electrode is small and therefore, the effect of limiting over-discharge of the positive electrode is decreased. The value given by the equation (3) is preferably 10 or more. Though no particular limitation is imposed on the upper limit of the above equation, it is preferably 50 or less. This is because when the value exceeds 50, there is a risk of the distribution of the nonaqueous electrolyte being inclined toward the negative electrode, causing the nonaqueous electrolyte at the positive electrode to dry up.

The average particle diameter of lithium-titanium composite oxide is preferably 1 μm or less, and the specific surface area measured by the BET method using N₂ adsorption is preferably in the range of 5 to 50 m²/g. When the specific surface area is defined in this range, the utilization factor of lithium-titanium composite oxide can be improved and therefore, a substantially high capacity can be obtained even in high rate charge-discharge operations.

In order to suppress over-discharge of the positive electrode, the negative electrode preferably contains a lithium absorption material (hereinafter referred to as a second negative electrode active material) that absorbes lithium ions at a potential higher than that of a lithium-titanium composite oxide (hereinafter referred to as a first negative electrode material) having a spinel structure. When the second negative electrode active material is contained in the negative electrode, decomposed products of the lithium salt represented by the above chemical formula (1) or (2) adsorb preferentially to the surface of the second negative electrode active material and therefore scarcely adsorb to the surface of the first negative electrode active material, thereby making it possible to maintain the large-current performance of the negative electrode at a high level.

Examples of the second negative electrode active material may include titanium-containing oxides, manganese-containing oxides, molybdenum-containing oxides, vanadium-containing oxides, niobium-containing oxides and copper-containing oxides. Among these oxides, niobium-containing oxides, molybdenum-containing oxides, manganese-containing oxides and copper-containing oxides and vanadium-containing oxides are superior in the effect of reducing the first charge-discharge efficiency of the negative electrode and are therefore preferable. These oxides may or may not contain lithium. Oxides containing no lithium are more increased in the amount of lithium to be absorbed than oxides containing lithium. Therefore, the effect of decreasing the first charge-discharge efficiency of the negative electrode is increased if the negative electrode is produced using an oxide containing no lithium as the second negative electrode active material. Examples of manganese-containing oxides containing no lithium may include MnO₂. Examples of oxides containing manganese and lithium may include LiₓMnO₂ (0<x≦3). When MnO₂ absorbes lithium ions, its compositional formula may be represented by LiₓMnO₂ (0<x≦3). Specifically, MnO₂ type oxides may be represented by LiₓMnO₂ (0≦x≦3). Other oxides may be likewise represented. Examples of the manganese-containing oxides may include, besides LiₓMnO₂ (0≦x≦3), Li₄₊ₓMn₅O₁₂ (0≦x≦3). Examples of the niobium-containing oxides may include LiₓNbO₃ (0≦x≦3). Examples of the molybdenum-containing oxides may include LiₓMoO₃ (0≦x≦3). Examples of the copper-containing oxides may include LiₓCuO (0≦x≦3). Examples of the vanadium-containing oxides may include LiₓV₂O₅ (0≦x≦3). Examples of titanium-containing oxides may include TiO₂. These second negative electrode active materials may be used either alone or in combinations of two or more.

Specific numerical values of lithium ion absorption potential of the aforementioned various compounds will be described in detail below (with respect to lithium ion absorption potential, see, for example, “The Latest Battery Handbook, Tsutomu Takamura (translator), Asakura Shoten (1996)”, p. 610, FIG. 36.2 and p. 802, FIG. 2.2).

Li₄₊ₓTi₅O₁₂: 1.50 to 1.55 V (vs. Li/Li⁺)

LiₓMnO₂: 2.7 to 3.0 V (vs. Li/Li⁺)

LiₓNb₂O₅: 1 to 2 V (vs. Li/Li⁺)

LiₓNbO₃: 1 to 2 V (vs. Li/Li⁺)

LiₓMoO₃: 2 to 3 V (vs. Li/Li⁺)

LiₓV₂O₅: 3.2 to 3.5 V (vs. Li/Li⁺)

LiₓV₆O₁₃: 2.2 to 3.3 V (vs. Li/Li⁺)

LiₓCuO: 1.8 to 2.4 V (vs. Li/Li⁺)

Lithium absorption materials, for example, LiₓNb₂O₅ and LiₓNbO₃, which are liable to absorb lithium ions at a potential close to or lower than the lithium ion absorption potential of the first negative electrode active material sometimes hinder the negative electrode active material from absorbing or desorbing lithium ions due to a change in the volume caused by the absorption or desorption of lithium ions. There is therefore a case where an increase in the content of the lithium absorption material causes the reversibility of charge-discharge, that is, the charge-discharge cycle performance, to deteriorate. The lithium ion absorption potential of the second negative electrode active material is preferably 1.8 V or higher and more preferably 2.0 V or higher. The lithium ion absorption potential is still more preferably 2.5 V or higher.

Manganese-containing oxides respectively have a lithium ion absorption potential of 2.0 V or more and are therefore preferably used as the second negative electrode active material. Among these manganese-containing oxides, LiₓMnO₂ (0≦x≦3) is preferable. Because LiₓMnO₂ produces excellent effects even in a small addition amount, it enables a high capacity and excellent cycle performance at the same time. When MnO₂ is used as the manganese-containing oxide, the structure of MnO₂ is preferably a β-type or γ-type. This is because a λ-type absorbes lithium ions at a potential close to 4 V and therefore, the effect of this embodiment is decreased when it is combined with a 4 V-type positive electrode active material such as LiCoO₂.

In the most desirable structure among the embodiments explained above, a lithium-titanium composite oxide having a spinel structure is used as the negative electrode active material, γ-type MnO₂ is used as the second negative electrode active material, and the ratio by weight of (A/B) is designed to be in the range of 3 to 50, wherein A is the weight (parts by weight) of the lithium-titanium composite oxide and B is the weight (parts by weight) of the second negative electrode active material.

The porosity of the negative electrode excluding the current collector is preferably in the range of 20 to 50%. This ensures that a negative electrode having high affinity with the nonaqueous electrolyte and a high density can be obtained. The porosity is more preferably in the range of 25 to 40%.

It is desirable for the current collector of the negative electrode to be formed of aluminum foil or aluminum alloy foil. It is also desirable for the current collector to have an average crystal grain size not larger than 50 μm. In this case, the mechanical strength of the current collector can be drastically increased so as to make it possible to increase the density of the negative electrode by applying the pressing under a high pressure to the negative electrode. As a result, the battery capacity can be increased. Also, since it is possible to prevent the dissolution and corrosion deterioration of the current collector in an over-discharge cycle under an environment of a high temperature not lower than, for example, 40° C., it is possible to suppress the elevation in the impedance of the negative electrode. Further, it is possible to improve the high-rate performance, the rapid charging performance, and the charge-discharge cycle performance of the battery. It is more desirable for the average crystal grain size of the current collector to be not larger than 30 μm, furthermore desirably, not larger than 5 μm.

The average crystal grain size can be obtained as follows. Specifically, the texture of the current collector surface is observed with an electron microscope so as to obtain the number n of crystal grains present within an area of 1 mm×1 mm. Then, the average crystal grain area S is obtained from the formula “S=1×10⁶/n (μm²)”, where n denotes the number of crystal grains noted above. Further, the average crystal grain size d (μm) is calculated from the area S by formula (4) given below:

d=2(S/π)^{1/2} (4)

The aluminum foil or the aluminum alloy foil having the average crystal grain size not larger than 50 μm can be complicatedly affected by many factors such as the composition of the material, the impurities, the process conditions, the history of the heat treatments and the heating conditions such as the annealing conditions, and the crystal grain size can be adjusted by an appropriate combination of the factors noted above during the manufacturing process.

It is desirable for the aluminum foil or the aluminum alloy foil to have a thickness not larger than 20 μm, more desirably not larger than 15 μm. Also, it is desirable for the aluminum foil to have a purity not lower than 99%. It is desirable for the aluminum alloy to contain another element such as magnesium, zinc or silicon. On the other hand, it is desirable for the amount of the transition metal such as iron, copper, nickel and chromium contained in the aluminum alloy to be not larger than 1%.

As the above conductive agent, for example, a carbon material may be used. Examples of the carbon material include acetylene black, carbon black, cokes, carbon fibers and graphite. In addition to the above, metal powders such as an aluminum powder and conductive ceramics such as TiO may also be given as examples of the conductive agent. The conductive agent is preferably cokes heat-treated at 800 to 2000° C. and having an average particle diameter of 10 μm or less, graphite and carbon fibers having an average particle diameter of 1 μm or less. The BET specific surface area of the above carbon material measured using N₂ adsorption is preferably 10 m²/g or more.

Examples of the above binder include polytetrafluoroethylene (PTFE), polyvinylidene fluoride (PVdF), fluoro rubber, styrene butadiene rubber and core shell binder.

With regard to each ratio of the negative electrode active material, negative electrode conductive agent and binder, it is preferable that the negative electrode active material be used in an amount range from 70% by weight to 96% by weight, the negative electrode conductive agent be used in an amount range from 2% by weight to 28% by weight and the binder be used in an amount range from 2% by weight to 28% by weight. When the amount of the negative electrode conductive agent is less than 2% by weight, the current collecting ability of the negative electrode active material-containing layer deteriorates, and there is therefore a risk of the large-current performance of the nonaqueous electrolyte secondary battery deteriorating. Also, when the amount of the binder is less than 2% by weight, the bonding ability between the negative electrode active material-containing layer and the negative electrode current collector deteriorates, and there is therefore a risk of the cycle performance deteriorating. On the other hand, each amount of the negative electrode conductive agent and binder is preferably 28% by weight or less in terms of obtaining high capacity.

The negative electrode is manufactured as follows: for example, the negative electrode active material, the negative electrode conductive agent and the binder are suspended in a common solvent to make a slurry, which is then applied to the negative electrode current collector and, dried to produce a negative electrode active material-containing layer, followed by pressing.

2) Nonaqueous Electrolyte

Given as examples of the nonaqueous electrolyte are liquid nonaqueous electrolyte prepared by dissolving an electrolyte in a nonaqueous solvent (organic solvent) and gel nonaqueous electrolyte obtained by making a complex of liquid nonaqueous electrolyte and polymer materials.

The nonaqueous electrolyte may contain a nonvolatile and nonflammable ionic liquid.

The electrolyte uses a lithium salt that is reduced at a potential higher than the lithium ion absorption potential of the negative electrode active material. As the first lithium salt, lithium Bis(Oxalate)Borate (LiBOB) represented by the chemical formula (1) or LiBF₂(Oₓ) represented by the chemical formula (2) is preferable.

The above first lithium salt and the second lithium salt are preferably mixed upon use. As the second lithium salt, at least one selected from lithium hexafluorophosphate (LiPF₆) and lithium tetrafluoroborate (LiBF₄) is used. Among these compounds, LiBF₄ is preferable.

A lithium salt other than the above first and second lithium salts may be contained. Examples of the other lithium salt include lithium salts such as lithium perchlorate (LiClO₄), lithium hexafluoroarsenate (LiAsF₆), lithium trifluoromethasulfonate (LiCF₃SO₃) and lithium bistrifluoromethylsulfonylimide [LiN(CF₃SO₂)₂]. As to the type of lithium salts to be used, one or two or more types may be used.

The concentration of lithium salt in the nonaqueous solvent (organic solvent) is preferably 0.5 mol/L or more and 2.5 mol/L or less.

Examples of the nonaqueous solvent (organic solvent) may include single or mixed solvents of cyclic carbonates such as propylene carbonate (PC), ethylene carbonate (EC) and vinylene carbonate; chain carbonates such as diethyl carbonate (DEC), dimethyl carbonate (DMC) and methyl ethyl carbonate (MEC); cyclic ethers such as tetrahydrofuran (THF), 2-methyltetrahydrofuran (2MeTHF) and dioxolan (DOX); chain ethers such as dimethoxyethane (DME) and diethoxyethane (DEE); γ-butyrolactone (GBL); acetonitrile (AN); and sulfolane (SL).

Examples of the polymer material may include polyvinylidene fluoride (PVdF), polyacrylonitrile (PAN) and polyethylene oxide (PEO).

Particularly, a larger effect is obtained in the case of using a liquid nonaqueous electrolyte containing γ-butyrolactone. As the organic solvent to be combined with γ-butyrolactone, propylene carbonate (PC) or ethylene carbonate (EC) is preferable. The organic solvent containing γ-butyrolactone are preferably mixture solvents prepared by mixing two or more solvents. When combining a liquid nonaqueous electrolyte containing γ-butyrolactone with a positive electrode containing cobalt as its major component, cobalt tends to be eluted in an over-discharge state. With the embodiments of the present invention, the elution of cobalt is limited and a resistance to over-discharge is improved.

The content of γ-butyrolactone in the nonaqueous solvent (organic solvent) is preferably designed to be 40% by volume or more and 95% by volume or less.

The ionic liquid means a salt in which at least a part thereof exhibits a liquid state at room temperature. The room temperature means a temperature range where power sources are assumed to usually work. The temperature range where power sources are assumed to usually work means a temperature range of which the upper limit is about 120° C. and, according to the case, about 60° C. and the lower limit is about −40° C. and according to the case, about −20° C. Particularly, a temperature range from −20° C. to 60° C. is preferable.

As the ionic liquid containing a lithium ion, an ionic liquid containing a lithium ion, an organic cation and an anion is preferably used. Also, this ionic liquid is preferably a liquid at a temperature lower than room temperature.

Examples of the above organic cation include an alkylimidazolium ion having the skeleton shown by the following [Chem. 3] and quaternary ammonium ion having the skeleton shown by the following [Chem. 3].

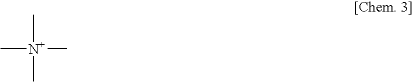

As the alkylimidazolium ion, a dialkyl imidazolium ion, trialkyl imidazolium ion, tetraalkyl imidazolium ion and the like are preferable. As the dialkyl imidazolium ion, 1-methyl-3-ethylimidazolium ion (MEI⁺) is preferable. As the trialkyl imidazolium ion, 1,2-diethyl-3-propylimidazolium ion (DMPI⁺) is preferable and as the tetraalkyl imidazolium ion, 1,2-diethyl-3,4(5)-dimethylimidazolium ion is preferable.

As the above quaternary ammonium ion, a tetraalkylammonium ion, cyclic ammonium ion and the like are preferable. As the tetraalkylammonium ion, a dimethylethylmethoxyammonium ion, dimethylethylmethoxymethylammonium ion, dimethylethylethoxyethylammonium ion and trimethylpropylammonium ion are preferable.

The use of the above alkylimidazolium ion or quaternary ammonium ion (particularly, tetraalkylammonium ion) ensures that the melting point of the ionic liquid may be made to be 100° C. or less and more preferably 20° C. or less. Also, the reactivity with the negative electrode can be decreased.

The concentration of the above lithium ion is preferably 20 mol % or less and more preferably in the range of 1 to 10 mol %. When the concentration of the lithium ion is in the above range, an ionic liquid can be obtained even at a temperature as low as 20° C. or less. Also, the viscosity of the ionic liquid can be dropped even at a temperature lower than room temperature and ion conductivity can be increased.

As the above anion, one or more anions selected from BF₄⁻, PF₆⁻, AsF₆⁻, ClO₄⁻, CF₃SO₃⁻, CF₃COO⁻, CH₃COO⁻, N(CF₃SO₂)₂⁻, N(C₂F₅SO₂)₂⁻, and (CF₃SO₂)₃C⁻ are preferably made to coexist. When plural anions are made to coexist, an ionic liquid having a melting point of 20° C. or less can be easily produced. It is more preferable that an ionic liquid having a melting point of 0° C. or less can be produced. More preferable examples of the anion include BF₄⁻, CF₃SO₃⁻, CF₃COO⁻, CH₃COO⁻, N(CF₃SO₂)₂⁻, N(C₂F₅SO₂)₂⁻, and (CF₃SO₂)₃C⁻. The use of these anions makes it easy to form an ionic liquid having a melting point of 0° C. or less.

3) Positive Electrode

The positive electrode comprises a positive electrode current collector and a positive electrode active material-containing layer which is laminated on one or both surfaces of the positive electrode current collector and contains a positive electrode active material, a positive electrode conductive agent and a binder.

The positive electrode active material is a lithium-transition metal composite oxide containing cobalt as its major component and having a composition represented by LiₓCo_{1-y}M_{y}O₂ (M is at least one selected from the II group to XIV group metals except for Co, 0≦x≦1.1, 0≦y<0.5). x varies in the range of 0≦x≦1.1, depending on charge and discharge reactions. Also, when y is made to be 0.5 or more, the effect of improving the cycle performance by using the first and second lithium salts is not observed. y is preferably in the range of 0.01≦y≦0.1.

Although one or more types selected from the elements of the II group to XIV group can be used. Among these elements, Mg, B, Al, Mn, Fe, Ni, Cu, Zn, Ga, Zr, Nb, Mo, Sn, Ta and W are preferable. More preferable elements are Mg, B, Al, Mn, Fe, Ni, Zr and Sn and still more preferable elements are Mg, Al, Mn, Ni, Zr and Sn.

In the positive electrode, lithium-manganese composite oxide (LiₓMn₂O₄), lithium-nickel composite oxide (LiₓNiO₂), lithium-nickel-cobalt composite oxide (LiₓNi_{1-y}Co_{y}O₂), spinel type lithium-manganese-nickel composite oxide (LiₓMn_{2-y}Ni_{y}O₄), lithium-manganese-cobalt composite oxide (LiₓMn_{y}Co_{1-y}O₂), lithium ironphosphate (LiₓFePO₄) or lithium-nickel-cobalt-manganese composite oxide may be mixed as a positive electrode sub active material upon use. x and y are respectively preferably in the range of 0 to 1.

The primary particle diameter of the positive electrode active material is preferably 100 nm or more and 1 μm or less. When the primary particle diameter is 100 nm or more, the positive electrode material is easily handled in industrial production. When the primary particle diameter is 1 μm or less, this enables lithium ions to be dispersed smoothly in a solid.

The specific surface area of the positive electrode active material is preferably 0.1 m²/g or more and 10 m²/g or less. When the specific surface area is 0.1 m²/g or more, a lithium ion-absorbing and desorbing site can be sufficiently secured. When the specific surface area is 10 m²/g or less, the positive electrode active material is easily handled in industrial production and good charge-discharge cycle performance can be secured.

Examples of the positive electrode conductive agent used to raise current collecting ability and to suppress contact resistance with the current collector may include carbonaceous materials such as acetylene black, carbon black and graphite.

Examples of the binder used to bind the positive electrode active material with the positive electrode conductive agent include polytetrafluoroethylene (PTFE), polyvinylidene fluoride (PVdF) and fluoro-rubber.

With regard to the ratio of the positive electrode active material, positive electrode conductive agent and binder, it is preferable that the amount of the positive electrode active material be 80% by weight or more and 95% by weight or less, the amount of the positive electrode conductive agent be 3% by weight or more and 18% by weight or less and the amount of the binder be 2% by weight or more and 17% by weight or less. When the amount of the positive electrode conductive agent is 3% by weight or more, the above effect can be produced whereas when the amount of the positive electrode conductive agent is 18% by weight or less, the decomposition of the nonaqueous electrolyte on the surface of the positive electrode conductive agent can be reduced when the battery is stored at high temperatures. As to the binder, when the amount of the binder is 2% by weight or more, sufficient electrode strength can be obtained whereas when the amount of the binder is 17% by weight or less, the amount of the insulating body of the electrode can be decreased and the inner resistance can be decreased.

It is desirable for the current collector to be formed of an aluminum foil or an aluminum alloy foil. It is desirable for the aluminum foil or the aluminum alloy foil forming the current collector to have an average crystal grain size not larger than 50 μm. It is more desirable for the average crystal grain size noted above to be not larger than 30 μm, and furthermore desirably not larger than 5 μm. Where the average crystal grain size of the aluminum foil or the aluminum alloy foil forming the current collector is not larger than 50 μm, the mechanical strength of the aluminum foil or the aluminum alloy foil can be drastically increased to make it possible to press the positive electrode with a high pressure. It follows that the density of the positive electrode can be increased to increase the battery capacity.

The aluminum foil or the aluminum alloy foil having the average crystal grain size not larger than 50 μm can be affected in a complicated fashion by many factors such as the composition of the material, the impurities, the process conditions, the history of the heat treatments and the heating conditions such as the annealing conditions, and the crystal grain size can be adjusted by an appropriate combination of the factors noted above during the manufacturing process.

It is desirable for the aluminum foil or the aluminum alloy foil to have a thickness not larger than 20 μm, preferably not larger than 15 μm. Also, it is desirable for the aluminum foil to have a purity not lower than 99%. Further, it is desirable for the aluminum alloy to contain, for example, magnesium, zinc and silicon. On the other hand, it is desirable for the content of the transition metals such as iron, copper, nickel and chromium in the aluminum alloy to be not higher than 1%.

Positive electrode is manufactured, for example, by suspending a positive electrode active material, positive electrode conductive agent and binder in an adequate solvent to produce a slurry, which is then applied to a positive electrode current collector and dried to produce a positive electrode active material-containing layer, followed by pressing. In addition, a positive electrode active material, positive electrode conductive agent and binder are formed into a pellet, which may be used in the positive electrode active material-containing layer.

4) Separator

Examples of the material for the separator may include porous films containing polyethylene, polypropylene, cellulose or polyvinylidene fluoride (PVdF) and synthetic resin nonwoven fabrics. Among these materials, porous films made of polyethylene or polypropylene melt at a predetermined temperature to thereby cut off current and is therefore preferable in terms of improving safety.

5) Outer Package Member

Examples of the outer package member include laminate films having a thickness of 0.2 mm or less and metal containers having a wall thickness of 0.5 mm or less. The wall thickness of the metal containers is more preferably 0.2 mm or less.

Examples of the shape of the metal container include a flat type, rectangular type, cylinder type, coin type, button type, sheet type and laminate type. The embodiments may be applied to, of course, large-sized batteries to be mounted on two-wheel motorcycles to four-wheel cars besides small-sized batteries to be mounted on portable electronic devices.

The laminate films are multilayer films constituted of a metal layer and a resin layer with which the metal layer is coated. The metal layer is preferably an aluminum foil or an aluminum alloy foil to develop a light-weight device. The resin layer is to reinforce a metal layer. For the resin layer, polymer compounds such as polypropylene (PP), polyethylene (PE), nylon and polyethylene terephthalate (PET) may be used. Laminate films are molded by carrying out sealing by heat fusion.

Examples of the material of the metal container include aluminum or aluminum alloys. As the aluminum alloy, alloys containing elements such as magnesium, zinc and silicon are preferable. On the other hand, the amount of transition metals such as iron, copper, nickel and chromium is preferably decreased to 1% or less. This makes it possible to outstandingly improve long-term reliability and heat radiation ability under a high-temperature circumstance.

A metal can made of aluminum or an aluminum alloy has an average crystal grain size of, preferably 50 μm or less, more preferably 30 μm or less and still more preferably 5 μm or less. When the above average crystal grain size is designed to be 50 μm or less, the strength of the metal can made of aluminum or an aluminum alloy can be outstandingly increased, which affords possibility of decreasing the wall thickness of the can. As a result, a battery which is light-weight, has a high output, is superior in long-term reliability and is preferably mountable on vehicles can be attained.

6) Negative Electrode Terminal

The negative electrode terminal may be formed from a material having electric stability and conductivity at a potential range from 0.3 to 3 V with respect to a lithium metal potential. Example of this material include aluminum and aluminum alloys containing elements such as Mg, Ti, Zn, Mn, Fe, Cu and Si. In order to reduce contact resistance, the material is preferably the same as that of the negative electrode current collector.

7) Positive Electrode Terminal

The positive electrode terminal may be formed from a material having electric stability and conductivity at a potential range from 3 V to 5 V with respect to a lithium metal potential. Example of this material include aluminum and aluminum alloys containing elements such as Mg, Ti, Zn, Mn, Fe, Cu and Si. In order to reduce contact resistance, the material is preferably the same as that of the positive electrode current collector.

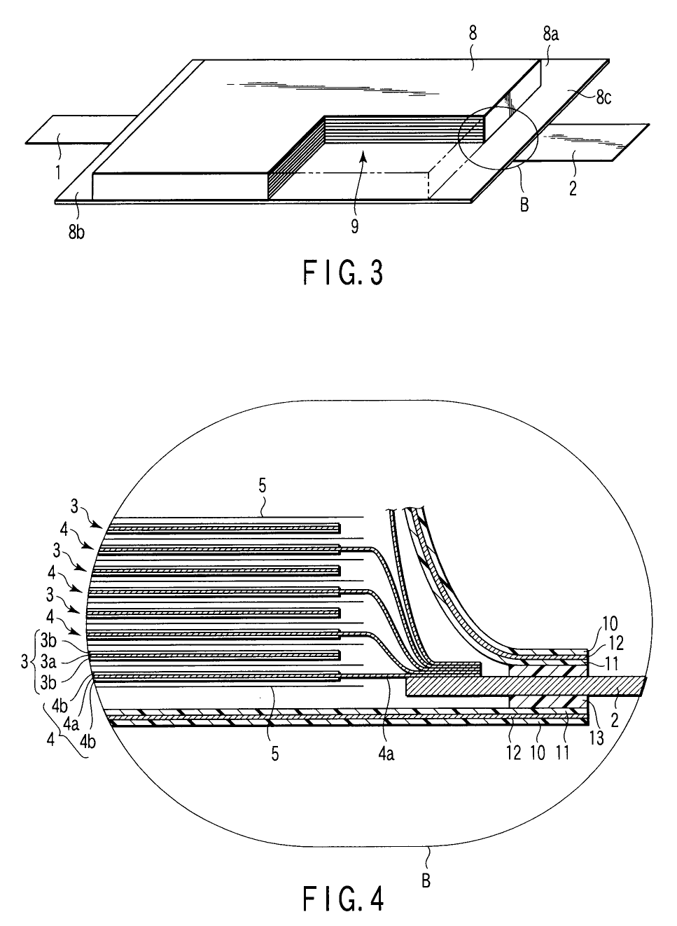

The nonaqueous electrolyte battery according to the embodiment of the present invention is not limited to the structures as shown in FIGS. 1 and 2, but may have the structures shown in FIGS. 3 and 4. FIG. 3 is a partially broken perspective view showing another flat type nonaqueous electrolyte battery according to the embodiment of the present invention and FIG. 4 is an enlarged sectional view of the B part of FIG. 3.

As shown in FIG. 3, a laminate type electrode group 9 is housed in an outer package member 8 made of a laminate film. The laminate film is provided with a resin layer 10, a thermoplastic resin layer 11, and a metal layer 12 disposed between the resin layer 10 and the thermoplastic resin layer 11 as shown in FIG. 4. The thermoplastic resin layer 11 is positioned on the inside surface of the outer package member 8. Heat seal parts 8a, 8b and 8c are formed by thermal fusion of the thermoplastic resin layer 11 on one long side and both short sides of the outer package member 8 made of a laminate film. The outer package member 8 is sealed by these heat seal parts 8a, 8b and 8c.

The laminate type electrode group 9 is provided with plural positive electrodes 3, plural negative electrodes 4 and a separator 5 interposed between each positive electrode 3 and each negative electrode 4. The laminate type electrode group 9 has a structure in which the positive electrode 3 and the negative electrode 4 are alternately laminated with the separator 5 interposed therebetween as shown in FIG. 4. Each positive electrode 3 is provided with a positive electrode current collector 3a and a positive electrode active material-containing layer 3b supported on both surfaces of the positive electrode current collector 3a. Each negative electrode 4 is provided with a negative electrode current collector 4a and a negative electrode active material-containing layer 4b supported on both surfaces of the negative electrode current collector 4a. One short side of each of the negative electrode current collectors 4a of the negative electrodes 4 is projected from the positive electrode 3. The negative electrode current collector 4a projected from the positive electrode 3 is electrically connected to a band-like negative electrode terminal 2. The end of the band-like negative electrode terminal 2 is drawn externally through the heat seal part 8c of the outer package member 8. Both surfaces of the negative electrode terminal 2 face the thermoplastic resin layer 11 constituting the heat seal part 8c. An insulating film 13 is interposed between each surface of the negative electrode terminal 2 and the thermoplastic resin layer 11 to improve the binding strength between the heat seal part 8c and the negative electrode terminal 2. Examples of the insulating film 13 may include films formed from materials obtained by adding an acid anhydride to polyolefin containing at least one of polypropylene and polyethylene.

Though not shown here, one short side of each of the positive electrode current collectors 3a of the positive electrodes 3 is projected from the negative electrode 4. The positive electrode current collector 3a and the negative electrode current collector 4a are projected in directions opposite to each other. The positive electrode current collector 3a projected from the negative electrode 4 is electrically connected to the band-like positive electrode terminal 1. The end of the band-like positive electrode terminal 1 is drawn externally through the heat seal part 8b of the outer package member 8. In order to improve the binding strength between the heat seal 8b and the positive electrode terminal 1, an insulating film 13 is interposed between the positive electrode terminal 1 and the thermoplastic resin layer 11. The positive electrode terminal 1 and the negative electrode terminal 2 are drawn in directions opposite to each other from the outer package member 8.

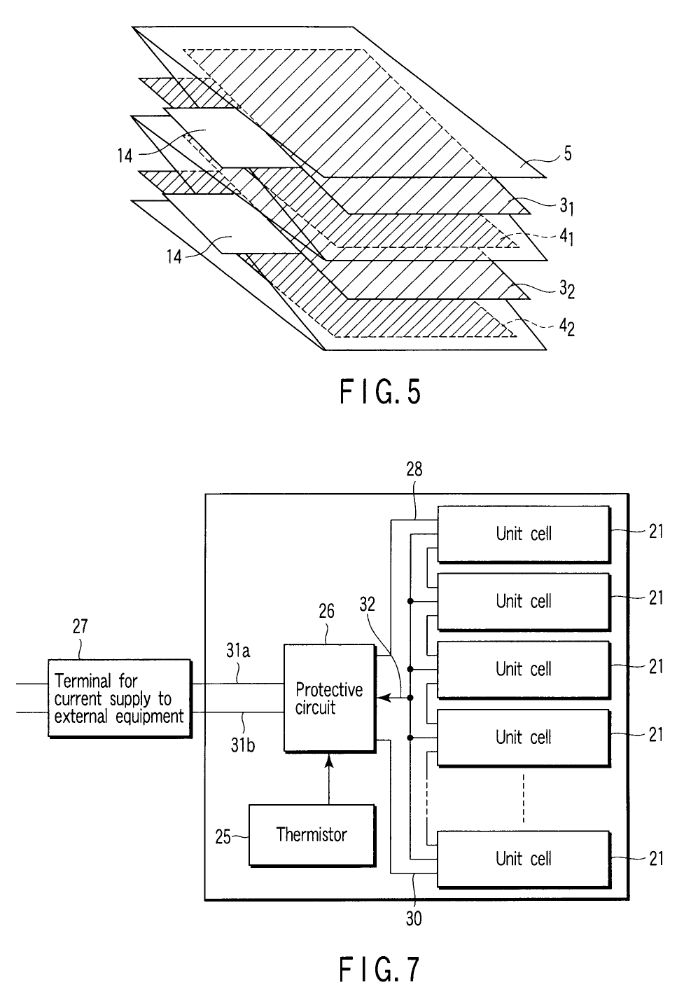

In order to attain high large-current performance also when the battery is used for a long period of time, the electrode group including the positive electrode and the negative electrode preferably has a laminate structure and the separator is folded in a zigzag shape prior to use as shown in FIG. 5. A band-shaped separator 5 is folded in a zigzag shape. A strip-like positive electrode 3₁, a strip-like negative electrode 4₁, a strip-like positive electrode 3₂ and a strip-like negative electrode 4₂ are inserted in this order from above into the overlapped part of the separators 5. A positive electrode terminal 14 is drawn from each short side of the strip-like positive electrodes 3₁ and 3₂. An electrode group having a laminate structure is obtained by alternately disposing the positive electrode 3 and the negative electrode 4 between the overlapped parts of the separator 5 folded in a zigzag shape in this manner.

When the separator is folded in a zigzag shape, three sides of each of the positive electrode and negative electrode are brought into direct contact with the nonaqueous electrolyte not through the separator and therefore, the nonaqueous electrolyte is smoothly moved to the electrode. Therefore, even if the nonaqueous electrolyte is consumed on the surface of the electrode during long-term use, the nonaqueous electrolyte is smoothly supplied, with the result that an excellent large-current performance (output/input performance) can be attained over a long period of time.

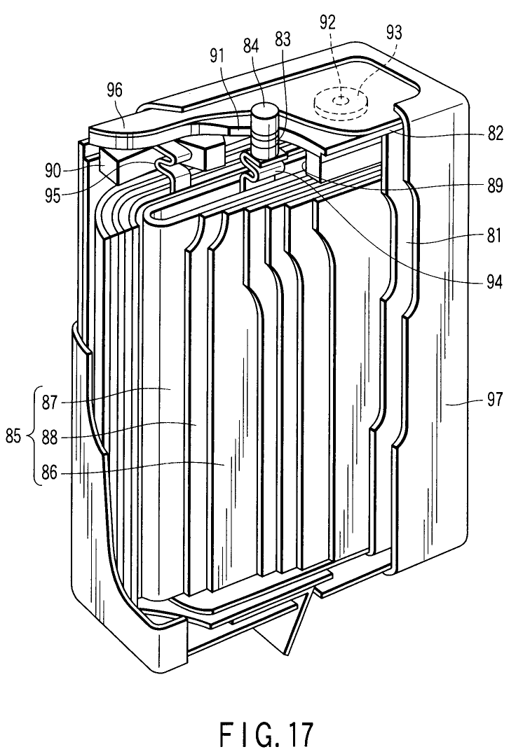

The nonaqueous electrolyte battery according to the embodiment of the present invention is not limited to the structure using a laminate film container as shown in FIGS. 1 to 4, but may have a structure using a metal container illustrated in FIG. 17.

The outer package member is provided with a container 81 which has a bottomed rectangular cylinder form and is made of aluminum or an aluminum alloy, a lid 82 disposed on an opening part of the container 81 and a negative electrode terminal 84 attached to the lid 82 through an insulating material 83. The container 81 also serves as a positive electrode terminal. As the above aluminum or aluminum alloy constituting the container 81, those having the aforementioned composition and average crystal grain size may be used.

An electrode group 85 is housed in the container 81. The electrode group 85 has a structure in which a positive electrode 86 and a negative electrode 87 are coiled through a separator 88 in a flat form. This electrode group 85 is obtained in the following manner: for example, a band-like product obtained by laminating the positive electrode 86, the separator 88 and the negative electrode 87 in this order is coiled in a spiral form by using a plate or cylindrical core such that the positive electrode 86 is positioned on the outside, and the obtained coiled product is molded under pressure in the radial direction.

The nonaqueous electrolytic solution (liquid nonaqueous electrolyte) is held in the electrode group 85. A spacer 90 which is provided with a lead-takeoff hole 89 in the vicinity of the center thereof and made of, for example, a synthetic resin is disposed on the electrode group 85 in the container 81.

A takeoff hole 91 for the negative electrode terminal 84 is opened in the vicinity of the center of the lid 82. A liquid injection port 92 is formed at a position apart from the takeoff hole 91 of the lid 82. The liquid injection port 92 is sealed with a seal plug 93 after the nonaqueous electrolytic solution is injected into the container 81. The negative electrode terminal 84 is hermetically sealed in the takeoff hole 91 of the lid 82 through a glass or resin insulating material 83.

A negative electrode lead tab 94 is welded to the lower bottom surface of the negative electrode terminal 84. The negative electrode lead tab 94 is electrically connected to the negative electrode 87. One end of a positive electrode lead 95 is electrically connected to the positive electrode 86 and the other end thereof is welded to the lower surface of the lid 82. An insulating paper 96 covers the entire outer surface of the lid 82. An outer package tube 97 covers the entire side surface of the container 81, and the upper and lower ends thereof are folded so as to cover the upper and lower surfaces of the battery body, respectively.

### Second Embodiment

A battery pack according to a second embodiment comprises plural nonaqueous electrolyte batteries according to the first embodiment as unit cells. Each unit cell is arranged electrically in series or in parallel and constitutes a battery module.

As mentioned above, the unit cell according to the first embodiment is superior in over-discharge resistance and specifically, can restrain the deterioration of the positive electrode in over-discharge. When a battery module is constituted of unit cells, there is the case where a part of the unit cells fall into an over-discharge state because of a dispersion in capacity between individual unit cells. However, the unit cell according to the first embodiment is resistant to the deterioration of the positive electrode caused by over-discharge and is therefore resistant to deterioration of the performance required for a battery module. For this reason, the battery pack according to the second embodiment has a wide allowable range of a dispersion of capacity between unit cells constituting a battery module, has excellent controllability of a battery module and is superior in cycle performance. As the unit cell, the flat type nonaqueous electrolyte battery shown in FIG. 1, 3 or 17 may be used.

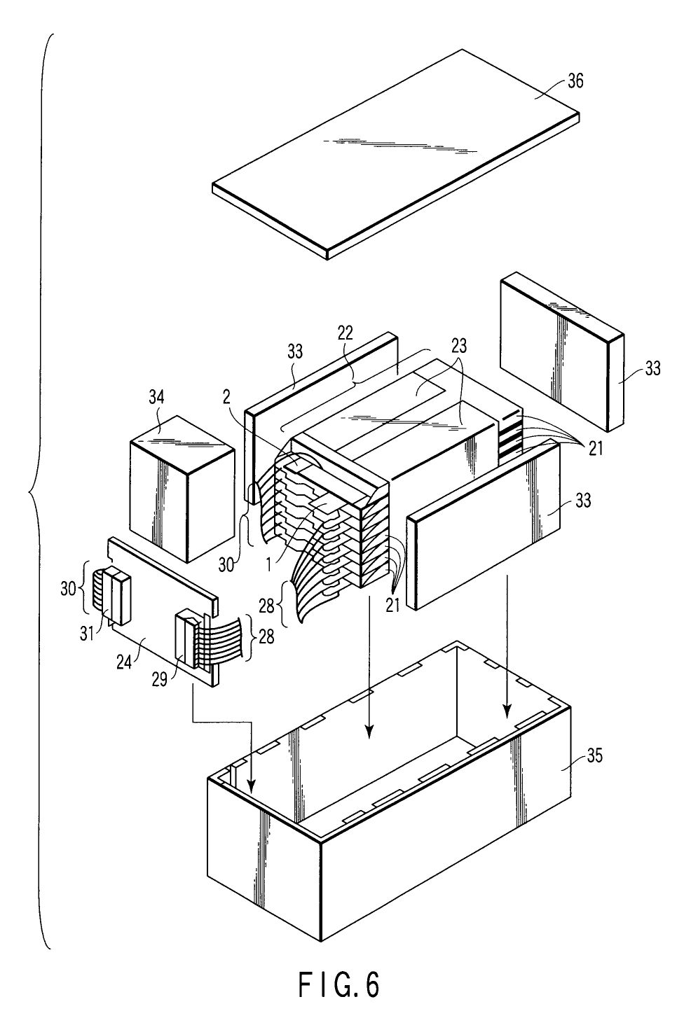

Each of a plurality of unit cells 21 included in the battery pack shown in FIG. 6 is formed of, though not limited to, a flattened type nonaqueous electrolyte battery constructed as shown in FIG. 1. The plural unit cells 21 are stacked one upon the other in the thickness direction in a manner to align the protruding directions of the positive electrode terminals 1 and the negative electrode terminals 2. As shown in FIG. 7, the unit cells 21 are connected in series to form a battery module 22. The unit cells 21 forming the battery module 22 are made integral by using an adhesive tape 23 as shown in FIG. 6.

A printed wiring board 24 is arranged on the side surface of the battery module 22 toward which protrude the positive electrode terminals 1 and the negative electrode terminals 2. As shown in FIG. 7, a thermistor 25, a protective circuit 26 and a terminal 27 for current supply to the external equipment are connected to the printed wiring board 24.

As shown in FIGS. 6 and 7, a wiring 28 on the side of the positive electrodes of the battery module 22 is electrically connected to a connector 29 on the side of the positive electrode of the protective circuit 26 mounted to the printed wiring board 24. On the other hand, a wiring 30 on the side of the negative electrodes of the battery module 22 is electrically connected to a connector 31 on the side of the negative electrode of the protective circuit 26 mounted to the printed wiring board 24.

The thermistor 25 detects the temperature of the unit cell 21 and transmits the detection signal to the protective circuit 26. The protective circuit 26 is capable of breaking a wiring 31a on the positive side and a wiring 31b on the negative side, the wirings 31a and 31b being stretched between the protective circuit 26 and the terminal 27 for current supply to the external equipment. These wirings 31a and 31b are broken by the protective circuit 26 under prescribed conditions including, for example, the conditions that the temperature detected by the thermistor is higher than a prescribed temperature, and that the over-charging, over-discharging and over-current of the unit cell 21 have been detected. The detecting method is applied to the unit cells 21 or to the battery module 22. In the case of applying the detecting method to each of the unit cells 21, it is possible to detect the battery voltage, the positive electrode potential or the negative electrode potential. On the other hand, where the positive electrode potential or the negative electrode potential is detected, lithium metal electrodes used as reference electrodes are inserted into the unit cells 21.

In the case of FIG. 7, a wiring 32 is connected to each of the unit cells 21 for detecting the voltage, and the detection signal is transmitted through these wirings 32 to the protective circuit 26.

Protective sheets 33 each formed of rubber or resin are arranged on the three of the four sides of the battery module 22, though the protective sheet 33 is not arranged on the side toward which protrude the positive electrode terminals 1 and the negative electrode terminals 2. A protective block 34 formed of rubber or resin is arranged in the clearance between the side surface of the battery module 22 and the printed wiring board 24.

The battery module 22 is housed in a container 35 together with each of the protective sheets 33, the protective block 34 and the printed wiring board 24. To be more specific, the protective sheets 33 are arranged inside the two long sides of the container 35 and inside one short side of the container 35. On the other hand, the printed wiring board 24 is arranged along that short side of the container 35 which is opposite to the short side along which one of the protective sheets 33 is arranged. The battery module 22 is positioned within the space surrounded by the three protective sheets 33 and the printed wiring board 24. Further, a lid 36 is mounted to close the upper open edge of the container 35.

Incidentally, it is possible to use a thermally shrinkable tube in place of the adhesive tape 23 for fixing the battery module 22. In this case, the protective sheets 33 are arranged on both sides of the battery module 22 and, after the thermally shrinkable tube is wound about the protective sheets, the tube is thermally shrunk to fix the battery module 22.

The unit cells 21 shown in FIGS. 6 and 7 are connected in series. However, it is also possible to connect the unit cells 21 in parallel to increase the cell capacity. Of course, it is possible to connect the battery packs in series and in parallel.

Also, the embodiments of the battery pack can be changed appropriately depending on the use of the battery pack.

The battery pack of the second embodiment is preferably applied to uses where cycle performance under a large current is desired. Specific examples of the application of the battery pack include uses as power sources of digital cameras, and uses for vehicles such as two- to four-wheel hybrid electric cars, two- to four-wheel electric cars and power-assisted bicycles. The uses for vehicles are particularly preferable.

In the case where as the nonaqueous electrolyte, a mixture solvent obtained by mixing at least one of propylene carbonate (PC) and ethylene carbonate (EC), and γ-butyrolactone (GBL) is used, uses for which high-temperature performance is desired are preferable. Specific examples of these uses include the aforementioned uses for vehicles.

### Third Embodiment

A vehicle according to a third embodiment comprises the battery pack according to the second embodiment. Generally, a current as large as about 10 C flows across a battery pack mounted on vehicles. When a large current flows, a large difference in temperature and impedance is caused between unit cells and therefore, a part of unit cells tend to fall into an over-discharge state. However, the unit cell of the first embodiment has a strong resistance to over-discharge, that is, a resistance to the deterioration of a positive electrode caused by over-discharge, and this is the reason why the battery pack of the second embodiment has an excellent cycle performance. The vehicle according to the third embodiment is excellent in maintaining the performance of the driving source. Examples of the vehicles according to the third embodiment include two- to four-wheel hybrid electric cars, two- to four-wheel electric cars and power-assisted bicycles.

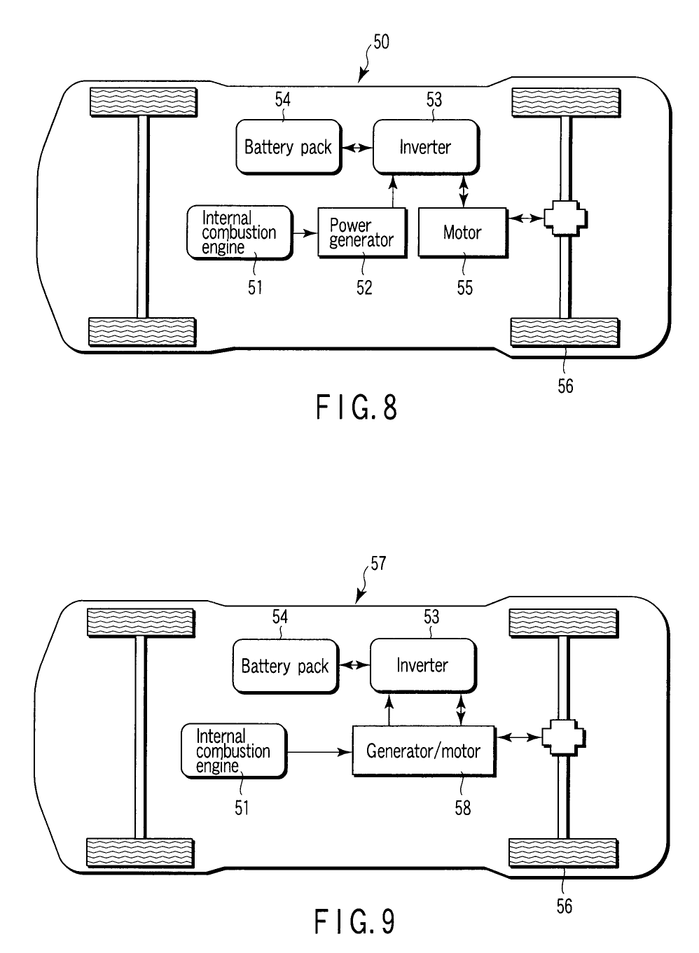

FIGS. 8 to 10 show various type of hybrid vehicles in which an internal combustion engine and a motor driven by a battery pack are used in combination as the power source for the driving. For driving the vehicle, required is the power source exhibiting a wide range of the rotation speed and the torque depending on the running conditions of the vehicle. Since the torque and the rotation speed exhibiting an ideal energy efficiency are limited in the internal combustion engine, the energy efficiency is lowered under the driving conditions other than the limited torque and the rotation speed. Since the hybrid vehicle includes the internal combustion engine and the electric motor, it is possible to improve the energy efficiency of the vehicle. Specifically, the internal combustion engine is operated under the optimum conditions so as to generate an electric power, and the wheels are driven by a high-efficiency electric motor, or the internal combustion engine and the electric motor are operated simultaneously, thereby improving the energy efficiency of the vehicle. Also, by recovering the kinetic energy of the vehicle in the decelerating stage as the electric power, the running distance per unit amount of the fuel can be drastically increased, compared with the vehicle that is driven by the internal combustion engine alone.

The hybrid vehicle can be roughly classified into three types depending on the combination of the internal combustion engine and the electric motor.

FIG. 8 shows a hybrid vehicle 50 that is generally called a series hybrid vehicle. The motive power of an internal combustion engine 51 is once converted entirely into an electric power by a power generator 52, and the electric power thus converted is stored in a battery pack 54 via an inverter 53. The battery pack according to the second embodiment is used as the battery pack 54. The electric power stored in the battery pack 54 is supplied to an electric motor 55 via the inverter 53, with the result that wheels 56 are driven by the electric motor 55. In other words, the hybrid vehicle 50 shown in FIG. 8 represents a system in which a power generator is incorporated into an electric vehicle. The internal combustion engine can be operated under highly efficient conditions and the kinetic energy of the internal combustion engine can be recovered as the electric power. On the other hand, the wheels are driven by the electric motor alone and, thus, the hybrid vehicle 50 requires an electric motor of a high output. It is also necessary to use a battery pack having a relatively large capacity. It is desirable for the rated capacity of the battery pack to fall within a range of 5 to 50 Ah, more desirably 10 to 20 Ah. Incidentally, the rated capacity noted above is the capacity at the time when the battery pack is discharged at a rate of 0.2 C.

FIG. 9 shows the construction of a hybrid vehicle 57 that is called a parallel hybrid vehicle. A reference numeral 58 shown in FIG. 9 denotes an electric motor that also acts as a power generator. The internal combustion engine 51 drives mainly the wheels 56. The motive power of the internal combustion engine 51 is converted in some cases into an electric power by the power generator 58, and the battery pack 54 is charged by the electric power produced from the power generator 58. In the starting stage or the accelerating stage at which the load is increased, the driving force is supplemented by the electric motor 58. The hybrid vehicle 57 shown in FIG. 9 represents a system based on the ordinary vehicle. In this system, the fluctuation in the load of the internal combustion engine 51 is suppressed so as to improve the efficiency, and the regenerative power is also obtained. Since the wheels 56 are driven mainly by the internal combustion engine 51, the output of the electric motor 58 can be determined arbitrarily depending on the required ratio of the assistance. The system can be constructed even in the case of using a relatively small electric motor 58 and a relatively small battery pack 54. The rated capacity of the battery pack can be set to fall within a range of 1 to 20 Ah, more desirably 3 to 10 Ah.

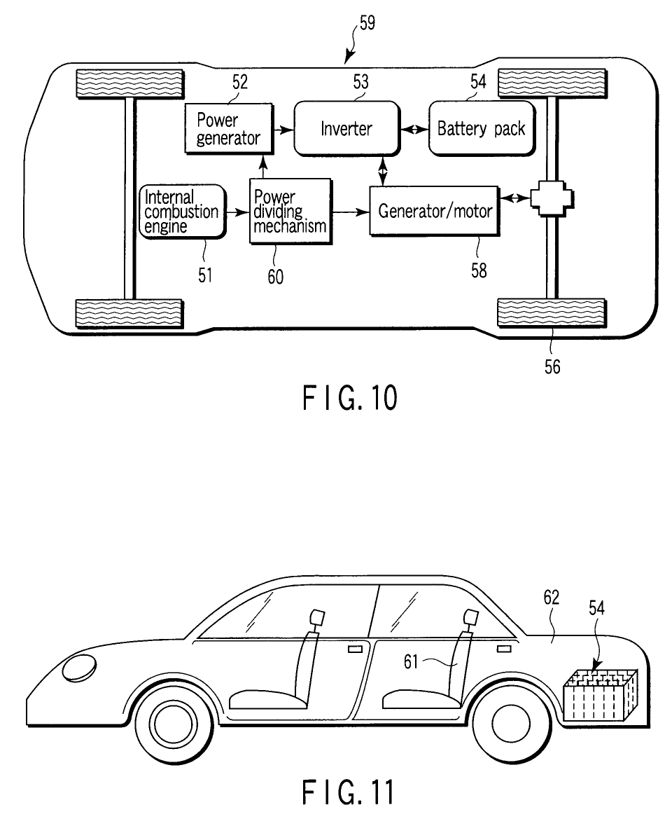

FIG. 10 shows the construction of a hybrid vehicle 59 that is called a series-parallel hybrid vehicle, which utilizes in combination both the series type system and the parallel type system. A power dividing mechanism 60 included in the hybrid vehicle 59 divides the output of the internal combustion engine 51 into the energy for the power generation and the energy for the wheel driving. The series-parallel hybrid vehicle 59 permits controlling the load of the engine more finely than the parallel hybrid vehicle so as to improve the energy efficiency.

It is desirable for the rated capacity of the battery pack to fall within a range of 1 to 20 Ah, more desirably 3 to 10 Ah.

It is desirable for the nominal voltage of the battery pack included in the hybrid vehicles as shown in FIGS. 8 to 10 to fall within a range of 200 to 600 V.

It is desirable for the battery pack 54 to be arranged in general in the site where the battery pack 54 is unlikely to be affected by the change in the temperature of the outer atmosphere and unlikely to receive an impact in the event of a collision. In, for example, a sedan type automobile shown in FIG. 11, the battery pack 54 can be arranged within a trunk room rearward of a rear seat 61. The battery pack 54 can also be arranged below or behind the rear seat 61. Where the battery has a large weight, it is desirable to arrange the battery pack 54 below the seat or below the floor in order to lower the center of gravity of the automobile.

An electric vehicle (EV) is driven by the energy stored in the battery pack that is charged by the electric power supplied from outside the vehicle. Therefore, it is possible for the electric vehicle to utilize the electric energy generated at a high efficiency by, for example, another power generating equipment. Also, since the kinetic energy of the vehicle can be recovered as the electric power in the decelerating stage of the vehicle, it is possible to improve the energy efficiency during the driving of the vehicle. It should also be noted that the electric vehicle does not discharge at all the waste gases such as a carbon dioxide gas and, thus, the air pollution problem need not be worried about at all. On the other hand, since all the power required for the driving of the vehicle is produced by an electric motor, it is necessary to use an electric motor of a high output. In general, it is necessary to store all the energy required for one driving in the battery pack by one charging. It follows that it is necessary to use a battery pack having a very large capacity. It is desirable for the rated capacity of the battery pack to fall within a range of 100 to 500 Ah, more desirably 200 to 400 Ah.

The weight of the battery pack occupies a large ratio of the weight of the vehicle. Therefore, it is desirable for the battery pack to be arranged in a low position that is not markedly apart from the center of gravity of the vehicle. For example, it is desirable for the battery pack to be arranged below the floor of the vehicle. In order to allow the battery pack to be charged in a short time with a large amount of the electric power required for the one driving, it is necessary to use a charger of a large capacity and a charging cable. Therefore, it is desirable for the electric vehicle to be equipped with a charging connector connecting the charger and the charging cable. A connector utilizing the electric contact can be used as the charging connector. It is also possible to use a non-contact type charging connector utilizing the inductive coupling.

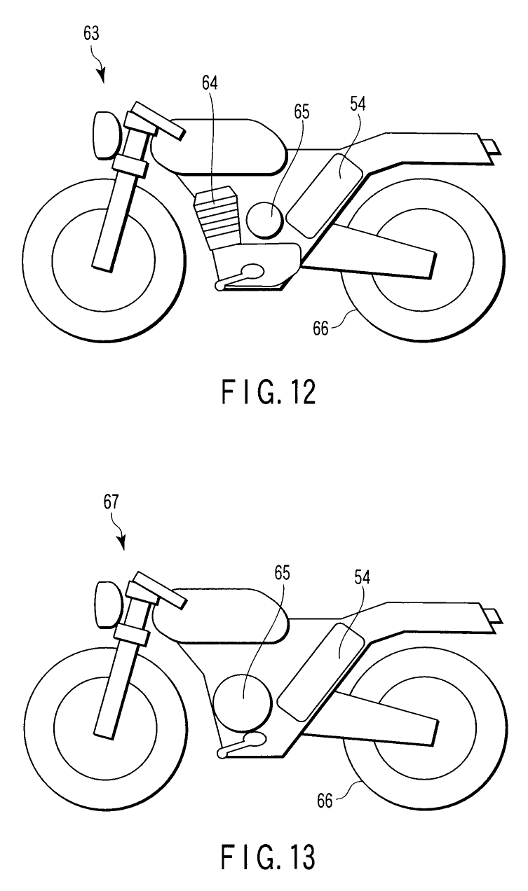

FIG. 12 exemplifies the construction of a hybrid motor bicycle 63. It is possible to construct a hybrid motor bicycle 63 exhibiting a high energy efficiency and equipped with an internal combustion engine 64, an electric motor 65, and the battery pack 54 like the hybrid vehicle. The internal combustion engine 64 drives mainly the wheels 66. In some cases, the battery pack 54 is charged by utilizing a part of the motive power generated from the internal combustion engine 64. In the starting stage or the accelerating stage in which the load of the motor bicycle is increased, the driving force of the motor bicycle is supplemented by the electric motor 65. Since the wheels 66 are driven mainly by the internal combustion engine 64, the output of the electric motor 65 can be determined arbitrarily based on the required ratio of the supplement. The electric motor 65 and the battery pack 54, which are relatively small, can be used for constructing the system. It is desirable for the rated capacity of the battery pack to fall within a range of 1 to 20 Ah, more desirably 3 to 10 Ah.

FIG. 13 exemplifies the construction of an electric motor bicycle 67. The electric motor bicycle 67 is driven by the energy stored in the battery pack 54 that is charged by the supply of the electric power from the outside. Since all the driving force required for the driving the motor bicycle 67 is generated from the electric motor 65, it is necessary to use the electric motor 65 of a high output. Also, since it is necessary for the battery pack to store all the energy required for one driving by one charging, it is necessary to use a battery pack having a relatively large capacity. It is desirable for the rated capacity of the battery pack to fall within a range of 10 to 50 Ah, more desirably 15 to 30 Ah.

### Fourth Embodiment

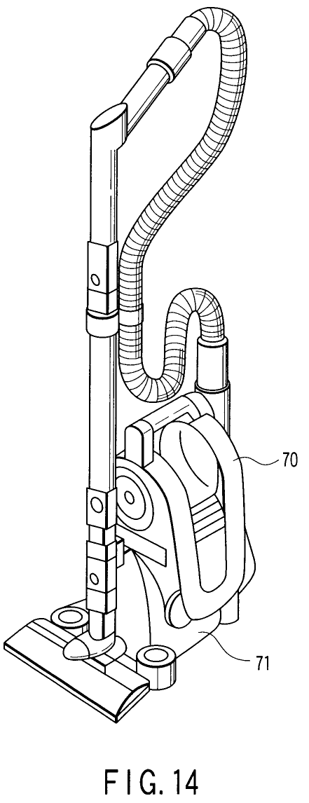

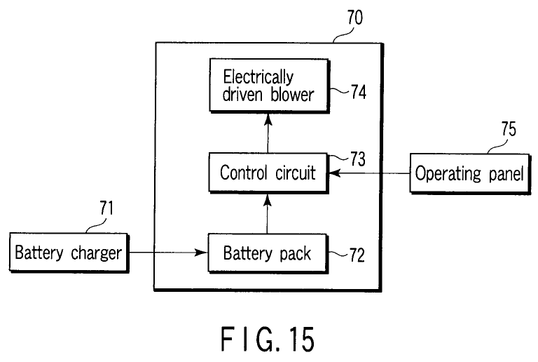

FIGS. 14 and 15 show an example of a rechargeable vacuum cleaner according to a fourth embodiment. The rechargeable vacuum cleaner comprises an operating panel 75 which selects operation modes, an electrically driven blower 74 comprising a fun motor for generating suction power for dust collection, and a control circuit 73. A battery pack 72 according to the second embodiment as a power source for driving these units are housed in a casing 70. When the battery pack is housed in such a portable device, the battery pack is desirably fixed with interposition of a buffer material in order to prevent the battery pack from being affected by vibration. Known technologies may be applied for maintaining the battery pack at an appropriate temperature. While a battery charger 71 that also serves as a setting table functions as the battery charger of the battery pack according to the second embodiment, a part or all of the function of the battery charger may be housed in the casing 70.

While the rechargeable vacuum cleaner consumes a large electric power, the rated capacity of the battery pack is desirably in the range of 2 to 10 Ah, more preferably 2 to 4 Ah, in terms of portability and operation time. The nominal voltage of the battery pack is desirably in the range of 40 to 80 V.

Generally, a large current of about 3 C to 5 C flows across a battery pack for a rechargeable vacuum cleaner and the rechargeable vacuum cleaner is used in all charge states from a fully charged state to a completely discharged state. When a large current flows, large differences in temperature and impedance are caused between unit cells and therefore, a part of unit cells tend to fall into an over-discharge state when the battery pack is in a completely discharged state. However, the unit cell of the first embodiment has a strong resistance to over-discharge, and this is the reason why the battery pack of the second embodiment has an excellent cycle performance. Therefore, the rechargeable vacuum cleaner according to the fourth embodiment has a strong resistance to repeated charge and discharge.

Examples will be explained. However, the present invention is not limited to the examples described below and any modification or variation are possible as long as it is within the concepts of the present invention.

### EXAMPLE 1

<Production of Positive Electrode>

First, 90% by weight of a lithium-cobalt oxide powder (LiCoO₂) having a layered crystal structure as a positive electrode active material, 5% by weight of acetylene black as a conductive agent, and 5% by weight of polyvinylidene fluoride (PVdF) were added to N-methylpyrrolidone (NMP) and these components were mixed to prepare a slurry. This slurry was applied to both surfaces of a current collector made of a 15-μm-thick aluminum foil and dried, followed by pressing to produce a positive electrode having an electrode density of 3.3 g/cm³.

<Production of Negative Electrode>

A powder of lithium titanate (Li₄Ti₅O₁₂) having a spinel structure, an average particle diameter of 0.82 μm and a specific surface area of 10.4 m²/g was prepared as a negative electrode active material. The specific surface area was measured by the BET method using N₂ adsorption.

One hundred parts by weight of the negative electrode active material, 7 parts by weight of cokes (d₀₀₂: 0.3465 nm, average particle diameter: 8.2 μm and BET specific surface area: 11.2 m²/g) obtained by baking at 1300° C. as a conductive agent, and 5 parts by weight of polyvinylidene fluoride (PVdF) were added to N-methylpyrrolidone (NMP) and these components were mixed to prepare a slurry. This slurry was applied to both surfaces of a current collector made of a 15-μm-thick aluminum foil (purity: 99.99%, average crystal grain size: 10 μm) and dried, followed by pressing to produce a negative electrode having an electrode density of 2.4 g/cm³. The BET specific surface area of the produced electrode which was measured by N₂ gas adsorption was 10.6 m²/g. At this time, the value of the formula (3) was 17.0.

<Preparation of Liquid Nonaqueous Electrolyte>

0.1% by weight of LiBOB as a first lithium salt and 1.5 mol/L of LiBF₄ as a second lithium salt were dissolved in a mixture solvent prepared by mixing ethylene carbonate (EC), propylene carbonate (PC) and γ-butyrolactone (GBL) in a ratio by volume of 1:1:2 (EC:PC:GBL), to prepare a liquid nonaqueous electrolyte.

<Measurement of Lithium Ion Absorption Potential of Negative Electrode Active Material>

The lithium ion absorption potential of the negative electrode active material was measured using the method explained below.

First, 100 parts by weight of the negative electrode active material, 5 parts by weight of cokes (d₀₀₂: 0.3465 nm, average particle diameter: 8.2 μm and BET specific surface area: 11.2 m²/g) obtained by baking at 1300° C. as a conductive agent, and 5 parts by weight of polyvinylidene fluoride (PVdF) were added to N-methylpyrrolidone (NMP) and these components were mixed to prepare a slurry. An electrode was prepared in the same manner as in the case of the above negative electrode except that this slurry was used. This electrode was cut into a size of 2 cm×2 cm to form a working electrode.

The working electrode was arranged to face a counter electrode formed of a lithium metal foil sized at 2.2 cm×2.2 cm with a glass filter (separator) interposed therebetween, and a lithium metal used as a reference electrode was inserted so as not to be brought into contact with any of the working electrode and the counter electrode. These electrodes were put in a glass cell of a three pole type such that each of the working electrode, the counter electrode and the reference electrode was connected to the terminal of the glass cell. Under the particular condition, 25 mL of an electrolytic solution, which was prepared by dissolving LiBF₄ in a concentration of 1.5 mol/L in a mixed solvent prepared by mixing ethylene carbonate (EC) and γ-butyrolactone (GBL) in a mixing ratio by volume of 1:2, was poured into the glass cell such that the separator and the electrodes were sufficiently impregnated with the electrolytic solution, followed by hermetically closing the glass cell.

The produced glass cell was placed in a constant temperature bath kept at 25° C. and potentially swept at a rate of 0.05 mV/sec at a working electrode potential range from 0.4 to 3.0 V (vs. Li/Li⁺) to carry out first measurement of cyclic voltammetry (CV). As a result, it was confirmed that the lithium ion absorption potential was 1.48 V (vs. Li/Li⁺).

<Measurement of Reducing Potential of First Lithium Salt>

The reducing potential of the first lithium salt was measured in the following measures.

A glass cell was manufactured to carry out CV measurement in the same manner as above except that 0.7 M/L LiBOB was used as the electrolyte. As a result, it was confirmed that the lithium ion absorption potential of the first lithium salt was 1.75 V (vs. Li/Li⁺).

<Production of Electrode Group>

The positive electrode, a separator made of a 25-μm-thick polyethylene porous film, the negative electrode and a separator were laminated in this order and then coiled spirally, and the coiled product was pressed under heating at 90° C. to thereby manufacture a flat type electrode group having a width of 30 mm and a thickness of 3.0 mm. The obtained electrode group was housed in a pack made of a 0.1-mm-thick laminate film constituted of a 40-μm-thick aluminum foil and polypropylene layers formed on both surfaces of the aluminum foil and was subjected to vacuum drying at 80° C. for 24 hours.

After a liquid nonaqueous electrolyte was injected into the laminate film pack in which the electrode group was housed, the pack was perfectly sealed by heat sealing to manufacture a nonaqueous electrolyte secondary battery that had the structure shown in FIG. 1 and a width of 35 mm, a thickness of 3.2 mm and a height of 65 mm.

The obtained battery was subjected to an over-discharge cycle test in which charge-discharge was repeated at a voltage of 2.8 V to 0.9 V under a 25° C. environment. The life of the cycle test was defined by the number of cycles when the capacity of the battery was dropped to 80% of the initial capacity. The results of the measured cycle life are shown in Table 1.

### EXAMPLES 2 TO 8

Nonaqueous electrolyte secondary batteries were produced in the same manner as in Example 1 except that the specific surface area of the negative electrode was controlled by adjusting the specific surface area of lithium titanate or the amount of the conductive agent.

### COMPARATIVE EXAMPLES 1 TO 3

Nonaqueous electrolyte secondary batteries were produced in the same manner as in Example 1 except that lithium titanates different in the specific surface area were used and the first lithium salt was not added.

### COMPARATIVE EXAMPLE 4

A nonaqueous electrolyte secondary battery was produced in the same manner as in Example 2 except that LiMn₂O₄ having a spinel type structure was used as the positive electrode active material.

### COMPARATIVE EXAMPLE 5

A nonaqueous electrolyte secondary battery was produced in the same manner as in Comparative Example 4 except that the first lithium salt was not added.

### COMPARATIVE EXAMPLE 6, EXAMPLES 9 TO 13, COMPARATIVE EXAMPLE 7

Nonaqueous electrolyte secondary batteries were produced in the same manner as in Example 1 except that the amount of the first lithium salt was changed.

### EXAMPLES 13-1 TO 13-3

Nonaqueous electrolyte secondary batteries were produced in the same manner as in Example 1 except that the composition of the positive electrode active material was changed.

### EXAMPLES 13-4 TO 13-5

Nonaqueous electrolyte secondary batteries were produced in the same manner as in Example 1 except that the amount of the second lithium salt to be added was changed.

### COMPARATIVE EXAMPLES 8 AND 9

Nonaqueous electrolyte secondary batteries were produced in the same manner as in Example 1 except that the amount of the second lithium salt to be added was changed.

### EXAMPLES 14 TO 26, COMPARATIVE EXAMPLES 8 TO 12

Nonaqueous electrolyte secondary batteries were produced in the same manner as in Examples 1 to 13, Comparative Examples 1 to 3 and Comparative Examples 6 and 7 except that LiBF₂(Oₓ) was used as the first lithium salt.

The reduction potential of LiBF₂(Oₓ) was measured by CV measurement in the same manner as above, to find that it was 1.55 V (vs. Li/Li⁺).

### EXAMPLES 26-1 TO 26-3

Nonaqueous electrolyte secondary batteries were produced in the same manner as in Example 14 except that the composition of the positive electrode active material was changed.

### EXAMPLE 26-4

A nonaqueous electrolyte secondary battery was produced in the same manner as in Example 14 except that the amount of the second lithium salt to be added was changed.

### COMPARATIVE EXAMPLES 15 AND 16

Nonaqueous electrolyte secondary batteries were produced in the same manner as in Example 14 except that the amount of the second lithium salt to be added was changed.

TABLE 1

| | | | | Negative | | |
|---|---|---|---|---|---|---|
| | | Negative electrode | | electrode | Negative | |
| | Positive | active material | | conductive agent | electrode | |
| | electrode | Specific surface | | Parts by | Specific surface | Value of |
| | active material | area [m²/g] | Parts by weight | weight | area [m²/g] | formula (3) |
| Example 1 | LiCoO₂ | 10.4 | 100 | 7 | 10.6 | 17.0 |
| Example 2 | LiCoO₂ | 10.4 | 100 | 5 | 8.1 | 15.2 |
| Example 3 | LiCoO₂ | 1.2 | 100 | 5 | 5.1 | 6.5 |
| Example 4 | LiCoO₂ | 0.4 | 100 | 5 | 4.2 | 5.7 |
| Example 5 | LiCoO₂ | 10.4 | 100 | 2 | 7.4 | 12.4 |
| Example 6 | LiCoO₂ | 1.2 | 100 | 2 | 2.8 | 3.4 |
| Example 7 | LiCoO₂ | 0.4 | 100 | 2 | 2.2 | 2.6 |
| Example 8 | LiCoO₂ | 10.4 | 100 | 0 | 6 | 10.4 |
| Comparative | LiCoO₂ | 10.4 | 100 | 5 | 8.1 | 15.2 |
| Example 1 | | | | | | |
| Comparative | LiCoO₂ | 1.2 | 100 | 5 | 5.1 | 6.5 |
| Example 2 | | | | | | |
| Comparative | LiCoO₂ | 0.4 | 100 | 5 | 4.2 | 5.7 |
| Example 3 | | | | | | |
| Comparative | LiMn₂O₄ | 10.4 | 100 | 5 | 8.1 | 15.2 |
| Example 4 | | | | | | |
| Comparative | LiMn₂O₄ | 10.4 | 100 | 5 | 8.1 | 15.2 |
| Example 5 | | | | | | |
| Comparative | LiCoO₂ | 10.4 | 100 | 7 | 10.6 | 17.0 |
| Example 6 | | | | | | |

| | Electrolytic solution | | | | | |
|---|---|---|---|---|---|---|
| | | First | Concentration | Second | Concentration | Cycle life |
| | Solvent | lithium salt | [wt %] | lithium salt | [M/L] | [Times] |
| Example 1 | EC/PC/GBL | LiBOB | 0.1 | LiBF₄ | 1.5 | 2000 |
| Example 2 | EC/PC/GBL | LiBOB | 0.1 | LiBF₄ | 1.5 | 1800 |
| Example 3 | EC/PC/GBL | LiBOB | 0.1 | LiBF₄ | 1.5 | 1200 |
| Example 4 | EC/PC/GBL | LiBOB | 0.1 | LiBF₄ | 1.5 | 1000 |
| Example 5 | EC/PC/GBL | LiBOB | 0.1 | LiBF₄ | 1.5 | 1600 |
| Example 6 | EC/PC/GBL | LiBOB | 0.1 | LiBF₄ | 1.5 | 800 |
| Example 7 | EC/PC/GBL | LiBOB | 0.1 | LiBF₄ | 1.5 | 700 |
| Example 8 | EC/PC/GBL | LiBOB | 0.1 | LiBF₄ | 1.5 | 1300 |
| Comparative | EC/PC/GBL | — | — | LiBF₄ | 1.5 | 450 |
| Example 1 | | | | | | |
| Comparative | EC/PC/GBL | — | — | LiBF₄ | 1.5 | 450 |
| Example 2 | | | | | | |
| Comparative | EC/PC/GBL | — | — | LiBF₄ | 1.5 | 400 |
| Example 3 | | | | | | |
| Comparative | EC/PC/GBL | LiBOB | 0.1 | LiBF₄ | 1.5 | 500 |
| Example 4 | | | | | | |
| Comparative | EC/PC/GBL | — | — | LiBF₄ | 1.5 | 500 |
| Example 5 | | | | | | |
| Comparative | EC/PC/GBL | LiBOB | 0.005 | LiBF₄ | 1.5 | 450 |
| Example 6 | | | | | | |

| | | | | Negative | | |
|---|---|---|---|---|---|---|
| | | Negative electrode | | electrode | Negative | |
| | Positive | active material | | conductive agent | electrode | |
| | electrode | Specific surface | | Parts by | Specific surface | Value of |
| | active material | area [m²/g] | Parts by weight | weight | area [m²/g] | formula (3) |
| Example 9 | LiCoO₂ | 10.4 | 100 | 7 | 10.6 | 17.0 |
| Example 10 | LiCoO₂ | 10.4 | 100 | 7 | 10.6 | 17.0 |
| Example 11 | LiCoO₂ | 10.4 | 100 | 7 | 10.6 | 17.0 |
| Example 12 | LiCoO₂ | 10.4 | 100 | 7 | 10.6 | 17.0 |
| Example 13 | LiCoO₂ | 10.4 | 100 | 7 | 10.6 | 17.0 |
| Comparative | LiCoO₂ | 10.4 | 100 | 7 | 10.6 | 17.0 |
| Example 7 | | | | | | |
| Example 13-1 | LiCo_{0.95}Sn_{0.05}O₂ | 10.4 | 100 | 7 | 10.6 | 17.0 |
| Example 13-2 | LiCo_{0.6}Ni_{0.2}Mn_{0.2}O₂ | 10.4 | 100 | 7 | 10.6 | 17.0 |
| Example 13-3 | LiCo_{0.9}Al_{0.1}O₂ | 10.4 | 100 | 7 | 10.6 | 17.0 |
| Example 13-4 | LiCoO₂ | 10.4 | 100 | 7 | 10.6 | 17.0 |
| Example 13-5 | LiCoO₂ | 10.4 | 100 | 7 | 10.6 | 17.0 |
| Comparative | LiCoO₂ | 10.4 | 100 | 7 | 10.6 | 17.0 |
| Example 8 | | | | | | |
| Comparative | LiCoO₂ | 10.4 | 100 | 7 | 10.6 | 17.0 |
| Example 9 | | | | | | |

| | Electrolytic solution | | | | | |
|---|---|---|---|---|---|---|
| | | First | Concentration | Second | Concentration | Cycle life |
| | Solvent | lithium salt | [wt %] | lithium salt | [M/L] | [Times] |
| Example 9 | EC/PC/GBL | LiBOB | 0.01 | LiBF₄ | 1.5 | 1000 |
| Example 10 | EC/PC/GBL | LiBOB | 0.02 | LiBF₄ | 1.5 | 1800 |
| Example 11 | EC/PC/GBL | LiBOB | 0.2 | LiBF₄ | 1.5 | 2500 |
| Example 12 | EC/PC/GBL | LiBOB | 0.3 | LiBF₄ | 1.5 | 3000 |
| Example 13 | EC/PC/GBL | LiBOB | 0.5 | LiBF₄ | 1.5 | 2500 |
| Comparative | EC/PC/GBL | LiBOB | 1.0 | LiBF₄ | 1.5 | 200 |
| Example 7 | | | | | | |
| Example 13-1 | EC/PC/GBL | LiBOB | 0.1 | LiBF₄ | 1.5 | 2500 |
| Example 13-2 | EC/PC/GBL | LiBOB | 0.1 | LiBF₄ | 1.5 | 2700 |
| Example 13-3 | EC/PC/GBL | LiBOB | 0.1 | LiBF₄ | 1.5 | 2500 |
| Example 13-4 | EC/PC/GBL | LiBOB | 0.1 | LiBF₄ | 1.0 | 2000 |
| Example 13-5 | EC/PC/GBL | LiBOB | 0.1 | LiBF₄ | 2.5 | 2000 |
| Comparative | EC/PC/GBL | LiBOB | 0.1 | LiBF₄ | 0.75 | 700 |
| Example 8 | | | | | | |
| Comparative | EC/PC/GBL | LiBOB | 0.1 | LiBF₄ | 2.75 | 800 |
| Example 9 | | | | | | |

TABLE 2

| | | | | Negative | | |
|---|---|---|---|---|---|---|
| | | Negative electrode | | electrode | Negative | |
| | Positive | active material | | conductive agent | electrode | |
| | electrode | Specific surface | | Parts by | Specific surface | Value of |
| | active material | area [m²/g] | Parts by weight | weight | area [m²/g] | formula (3) |
| Example 14 | LiCoO₂ | 10.4 | 100 | 7 | 10.6 | 17.0 |
| Example 15 | LiCoO₂ | 10.4 | 100 | 5 | 8.1 | 15.2 |
| Example 16 | LiCoO₂ | 1.2 | 100 | 5 | 5.1 | 6.5 |
| Example 17 | LiCoO₂ | 0.4 | 100 | 5 | 4.2 | 5.7 |
| Example 18 | LiCoO₂ | 10.4 | 100 | 2 | 7.4 | 12.4 |
| Example 19 | LiCoO₂ | 1.2 | 100 | 2 | 2.8 | 3.4 |
| Example 20 | LiCoO₂ | 0.4 | 100 | 2 | 2.2 | 2.6 |
| Example 21 | LiCoO₂ | 10.4 | 100 | 0 | 6 | 10.4 |
| Comparative | LiCoO₂ | 10.4 | 100 | 5 | 8.1 | 15.2 |
| Example 10 | | | | | | |
| Comparative | LiCoO₂ | 1.2 | 100 | 5 | 5.1 | 6.5 |
| Example 11 | | | | | | |
| Comparative | LiCoO₂ | 0.4 | 100 | 5 | 4.2 | 5.7 |
| Example 12 | | | | | | |
| Comparative | LiCoO₂ | 10.4 | 100 | 7 | 10.6 | 17.0 |
| Example 13 | | | | | | |

| | Electrolytic solution | | | | | |
|---|---|---|---|---|---|---|
| | | First | Concentration | Second | Concentration | Cycle life |
| | Solvent | lithium salt | [wt %] | lithium salt | [M/L] | [Times] |
| Example 14 | EC/PC/GBL | LiBF₂(Oₓ) | 0.1 | LiBF₄ | 1.0 | 1800 |
| Example 15 | EC/PC/GBL | LiBF₂(Oₓ) | 0.1 | LiBF₄ | 1.0 | 1600 |
| Example 16 | EC/PC/GBL | LiBF₂(Oₓ) | 0.1 | LiBF₄ | 1.0 | 1000 |
| Example 17 | EC/PC/GBL | LiBF₂(Oₓ) | 0.1 | LiBF₄ | 1.0 | 850 |
| Example 18 | EC/PC/GBL | LiBF₂(Oₓ) | 0.1 | LiBF₄ | 1.0 | 1300 |
| Example 19 | EC/PC/GBL | LiBF₂(Oₓ) | 0.1 | LiBF₄ | 1.0 | 750 |
| Example 20 | EC/PC/GBL | LiBF₂(Oₓ) | 0.1 | LiBF₄ | 1.0 | 700 |
| Example 21 | EC/PC/GBL | LiBF₂(Oₓ) | 0.1 | LiBF₄ | 1.0 | 1000 |
| Comparative | EC/PC/GBL | — | — | LiBF₄ | 1.0 | 450 |
| Example 10 | | | | | | |
| Comparative | EC/PC/GBL | — | — | LiBF₄ | 1.0 | 400 |
| Example 11 | | | | | | |
| Comparative | EC/PC/GBL | — | — | LiBF₄ | 1.0 | 400 |
| Example 12 | | | | | | |
| Comparative | EC/PC/GBL | LiBF₂(Oₓ) | 0.005 | LiBF₄ | 1.5 | 450 |
| Example 13 | | | | | | |

| | | | | Negative | | |
|---|---|---|---|---|---|---|
| | | Negative electrode | | electrode | Negative | |
| | Positive | active material | | conductive agent | electrode | |
| | electrode | Specific surface | | Parts by | Specific surface | Value of |
| | active material | area [m²/g] | Parts by weight | weight | area [m²/g] | formula (3) |
| Example 22 | LiCoO₂ | 10.4 | 100 | 7 | 10.6 | 17.0 |
| Example 23 | LiCoO₂ | 10.4 | 100 | 7 | 10.6 | 17.0 |
| Example 24 | LiCoO₂ | 10.4 | 100 | 7 | 10.6 | 17.0 |
| Example 25 | LiCoO₂ | 10.4 | 100 | 7 | 10.6 | 17.0 |
| Example 26 | LiCoO₂ | 10.4 | 100 | 7 | 10.6 | 17.0 |
| Comparative | LiCoO₂ | 10.4 | 100 | 7 | 10.6 | 17.0 |
| Example 14 | | | | | | |
| Example 26-1 | LiCo_{0.95}Sn_{0.05}O₂ | 10.4 | 100 | 7 | 10.6 | 17.0 |
| Example 26-2 | LiCo_{0.6}Ni_{0.2}Mn_{0.2}O₂ | 10.4 | 100 | 7 | 10.6 | 17.0 |
| Example 26-3 | LiCo_{0.9}Al_{0.1}O₂ | 10.4 | 100 | 7 | 10.6 | 17.0 |
| Example 26-4 | LiCoO₂ | 10.4 | 100 | 7 | 10.6 | 17.0 |
| Comparative | LiCoO₂ | 10.4 | 100 | 7 | 10.6 | 17.0 |
| Example 15 | | | | | | |
| Comparative | LiCoO₂ | 10.4 | 100 | 7 | 10.6 | 17.0 |
| Example 16 | | | | | | |

| | Electrolytic solution | | | | | |
|---|---|---|---|---|---|---|
| | | First | Concentration | Second | Concentration | Cycle life |
| | Solvent | lithium salt | [wt %] | lithium salt | [M/L] | [Times] |
| Example 22 | EC/PC/GBL | LiBF₂(Oₓ) | 0.01 | LiBF₄ | 1.5 | 950 |
| Example 23 | EC/PC/GBL | LiBF₂(Oₓ) | 0.02 | LiBF₄ | 1.5 | 1600 |
| Example 24 | EC/PC/GBL | LiBF₂(Oₓ) | 0.2 | LiBF₄ | 1.5 | 2300 |
| Example 25 | EC/PC/GBL | LiBF₂(Oₓ) | 0.3 | LiBF₄ | 1.5 | 2700 |
| Example 26 | EC/PC/GBL | LiBF₂(Oₓ) | 0.5 | LiBF₄ | 1.5 | 2200 |
| Comparative | EC/PC/GBL | LiBF₂(Oₓ) | 1.0 | LiBF₄ | 1.5 | 250 |
| Example 14 | | | | | | |
| Example 26-1 | EC/PC/GBL | LiBF₂(Oₓ) | 0.1 | LiBF₄ | 1.0 | 2350 |
| Example 26-2 | EC/PC/GBL | LiBF₂(Oₓ) | 0.1 | LiBF₄ | 1.5 | 2500 |
| Example 26-3 | EC/PC/GBL | LiBF₂(Oₓ) | 0.1 | LiBF₄ | 1.5 | 2300 |
| Example 26-4 | EC/PC/GBL | LiBF₂(Oₓ) | 0.1 | LiBF₄ | 2.5 | 1800 |
| Comparative | EC/PC/GBL | LiBF₂(Oₓ) | 0.1 | LiBF₄ | 0.75 | 500 |
| Example 15 | | | | | | |
| Comparative | EC/PC/GBL | LiBF₂(Oₓ) | 0.1 | LiBF₄ | 2.75 | 700 |
| Example 16 | | | | | | |

As is clear from Tables 1 and 2, it is understood that the addition of LiBOB or LiBF₂(Oₓ) improves the charge-discharge cycle life of the battery. It is also found that its effect is significant when using a negative electrode having a specific surface area of larger than 4 m²/g.

Also, the effect of the addition of the first lithium salt is not confirmed when LiMn₂O₄ having a spinel structure was used as the positive electrode active material. It is found that this effect is specific to LiCoO₂ having a layered crystal structure. From the results of Examples 13-1 to 13-3 and Examples 26-1 to 26-3, it has been confirmed that the effect of addition of the first lithium salt is obtained in a range of the composition given by the formula LiₓCo₁₋ₓM_{y}O₂ (M is at least one selected from the II to XIV group metals excluding Co, 0≦x≦1.1, 0≦y<0.5). Also, from comparison between Example 1 and Examples 13-1 to 13-3 and comparison between Example 14 and Examples 26-1 to 26-3, it is understood that the positive electrode active material having a composition using an element M is rather superior in cycle performance.

From comparison between Examples 9 to 13 and Comparative Examples 6 and 7 and comparison between Examples 22 to 26 and Comparative Examples 13 and 14, it is understood that the effect is observed when the amount of the first lithium salt to be added is in the range of 0.01 to 0.5% by weight and a particularly excellent cycle performance is obtained when the amount of the first lithium salt is in the range of 0.2 to 0.5% by weight. Moreover, as shown by the results of Comparative Examples 8, 9, 15 and 16, even if the first lithium salt was added, the cycle performance was not improved when the content of the second lithium salt was out of the defined range.

### EXAMPLES 27 TO 34

Nonaqueous electrolyte batteries of Examples 27 to 34 were manufactured in the same manner as in Example 1 except that in the negative electrode, the second negative electrode active material was added in an amount of 3 parts by weight with respect to 100 parts by weight of spinel type lithium titanate. The weight ratio (A/B) was 33. 1 C and 10 C discharge operations of each battery produced in Examples 1 and 27 to 34 were carried out to find the ratio of 10 C discharge capacity to 1 C discharge capacity. The measured values are described in Table 3.

TABLE 3

| | | Second negative | | | | | | | |
|---|---|---|---|---|---|---|---|---|---|
| | Positive | electrode active | | Electrolytic solution | | | | | 10 C/1 C |
| | electrode | material | | | First | | Second | | capacity |
| | active | | Amount to be added | | lithium | Concentration | lithium | Concentration | ratio |
| | material | Type | [parts by weight] | Solvent | salt | [wt %] | salt | [M/L] | [%] |
| Example 1 | LiCoO₂ | — | — | EC/PC/GBL | LiBOB | 0.1 | LiBF₄ | 1.5 | 78 |
| Example 27 | LiCoO₂ | Li₂Ti₃O₇ | 3 | EC/PC/GBL | LiBOB | 0.1 | LiBF₄ | 1.5 | 87 |
| Example 28 | LiCoO₂ | MnO₂ | 3 | EC/PC/GBL | LiBOB | 0.1 | LiBF₄ | 1.5 | 87 |
| Example 29 | LiCoO₂ | Nb₂O₅ | 3 | EC/PC/GBL | LiBOB | 0.1 | LiBF₄ | 1.5 | 82 |
| Example 30 | LiCoO₂ | NbO₃ | 3 | EC/PC/GBL | LiBOB | 0.1 | LiBF₄ | 1.5 | 83 |
| Example 31 | LiCoO₂ | MoO₃ | 3 | EC/PC/GBL | LiBOB | 0.1 | LiBF₄ | 1.5 | 83 |
| Example 32 | LiCoO₂ | V₂O₅ | 3 | EC/PC/GBL | LiBOB | 0.1 | LiBF₄ | 1.5 | 85 |
| Example 33 | LiCoO₂ | V₆O₁₃ | 3 | EC/PC/GBL | LiBOB | 0.1 | LiBF₄ | 1.5 | 83 |
| Example 34 | LiCoO₂ | CuO | 3 | EC/PC/GBL | LiBOB | 0.1 | LiBF₄ | 1.5 | 87 |

As is clear from Table 3, it is understood that the large-current performance is improved when the second negative electrode active material is added to the negative electrode. In other words, it is clear that the large-current performance is improved by addition of the second negative electrode active material.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A nonaqueous electrolyte battery comprising:
a positive electrode containing a positive electrode active material represented by the formula LiₓCo_{1-y}M_{y}O₂ (M is at least one selected from the II group to XIV group metals except for Co, 0≦x≦1.1, 0≦y<0.5);
a negative electrode containing a negative electrode active material which is a lithium-titanium composite oxide having a spinel structure; and
a nonaqueous electrolyte containing a nonaqueous solvent containing γ-butyrolactone, 0.01 to 0.5% by weight of a first lithium salt which is dissolved in the nonaqueous solvent and is at least one of lithium salts represented by the following chemical formula (1) or (2), and 1 to 2.5 M/L of a second lithium salt which is dissolved in the nonaqueous solvent and is at least one selected from the group consisting of LiBF₄ and LiPF₆.

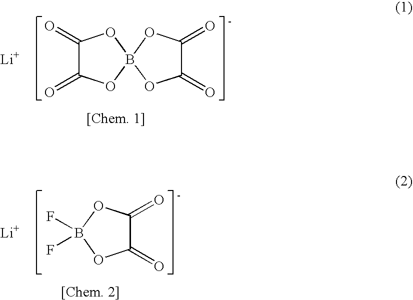

2. The nonaqueous electrolyte battery according to claim 1, wherein the nonaqueous solvent further contains at least one of propylene carbonate and ethylene carbonate.

3. The nonaqueous electrolyte battery according to claim 1, wherein the negative electrode further comprises a current collector supporting the negative electrode active material and a specific surface area of the negative electrode excluding the current collector is 4 m²/g or more.

4. The nonaqueous electrolyte battery according to claim 1, wherein the negative electrode further contains a second negative electrode active material made of an oxide having a lithium ion absorption potential of 1.8 V (vs. Li/Li⁺) or more.

5. The nonaqueous electrolyte battery according to claim 4, wherein the second negative electrode active material is at least one selected from the group consisting of a manganese-containing oxide, a molybdenum-containing oxide, a vanadium-containing oxide, a niobium-containing oxide and a copper-containing oxide.

6. The nonaqueous electrolyte battery according to claim 4, wherein the second negative electrode active material is represented by LiₓMnO₂ (0≦x≦3).

7. The nonaqueous electrolyte battery according to claim 1, wherein the lithium-titanium composite oxide is represented by Li₄₊ₓTi₅O₁₂ (0≦x≦3).

8. The nonaqueous electrolyte battery according to claim 1, wherein a content of the first lithium salt in the nonaqueous electrolyte is 0.2 to 0.5% by weight and a concentration of the second lithium salt in the nonaqueous solvent is 1.2 to 2 M/L.

9. The nonaqueous electrolyte battery according to claim 1, wherein y satisfies the following equation: 0.01≦y≦0.1 and M is at least one element selected from the group consisting of Mg, B, Al, Mn, Fe, Ni, Cu, Zn, Ga, Zr, Nb, Mo, Sn, Ta and W.

10. A battery pack comprising a nonaqueous electrolyte battery,
wherein the nonaqueous electrolyte battery comprises:
a positive electrode containing a positive electrode active material represented by the formula LiₓCo_{1-y}M_{y}O₂ (M is at least one selected from the II group to XIV group metals except for Co, 0≦x≦1.1, 0≦y<0.5);
a negative electrode containing a negative electrode active material which is a lithium-titanium composite oxide having a spinel structure; and
a nonaqueous electrolyte containing a nonaqueous solvent containing γ-butyrolactone, 0.01 to 0.5% by weight of a first lithium salt which is dissolved in the nonaqueous solvent and is at least one of lithium salts represented by the following chemical formula (1) or (2), and 1 to 2.5 M/L of a second lithium salt which is dissolved in the nonaqueous solvent and is at least one selected from the group consisting of LiBF₄ and LiPF₆.

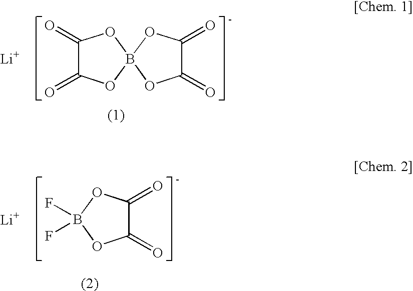

11. The battery pack according to claim 10, wherein the nonaqueous solvent further contains at least one of propylene carbonate and ethylene carbonate.

12. The battery pack according to claim 10, wherein the negative electrode further comprises a current collector supporting the negative electrode active material and a specific surface area of the negative electrode excluding the current collector is 4 m²/g or more.

13. The battery pack according to claim 10, wherein the negative electrode further contains a second negative electrode active material made of an oxide having a lithium ion absorption potential of 1.8 V (vs. Li/Li⁺) or more.

14. The battery pack according to claim 13, wherein the second negative electrode active material is at least one selected from the group consisting of a manganese-containing oxide, a molybdenum-containing oxide, a vanadium-containing oxide, a niobium-containing oxide and a copper-containing oxide.

15. The battery pack according to claim 13, wherein the second negative electrode active material is represented by LiₓMnO₂ (0≦x≦3).

16. The battery pack according to claim 10, wherein the lithium-titanium composite oxide is represented by Li₄₊ₓTi₅O₁₂ (0≦x≦3).

17. The battery pack according to claim 10, wherein a content of the first lithium salt in the nonaqueous electrolyte is 0.2 to 0.5% by weight and a concentration of the second lithium salt in the nonaqueous solvent is 1.2 to 2 M/L.

18. The battery pack according to claim 10, wherein y satisfies the following equation: 0.01≦y≦0.1 and M is at least one element selected from the group consisting of Mg, B, Al, Mn, Fe, Ni, Cu, Zn, Ga, Zr, Nb, Mo, Sn, Ta and W.

19. A vehicle comprising the battery pack according to claim 10.
